(19) United States
(12) Patent Application Publication
(10) Pub. No.: US 2016/0014790 A1
(43) Pub. Date: Jan. 14, 2016

(54) WIRELESS COMMUNICATION SYSTEM

(71) Applicant: SHARP KABUSHIKI KAISHA, Osaka (JP)

(72) Inventors: Shuichi TAKEHANA, Osaka-shi (JP); Hidenobu FUKUMASA, Osaka-shi (JP); Toshiaki KAMENO, Osaka-shi (JP); Shusaku FUKUMOTO, Osaka-shi (JP); Yuichi NOBUSAWA, Osaka-shi (JP)

(73) Assignee: Sharp Kabushiki Kaisha, Osaka-shi, Osaka (JP)

(21) Appl. No.: 14/435,498

(22) PCT Filed: Nov. 26, 2013
(86) PCT No.: PCT/JP2013/081740

§ 371 Date: Apr. 14, 2015

(30) Foreign Application Priority Data
Jan. 30, 2013 (JP) 2013-015793

(51) Int. Cl. H04W 72/08; H04W 72/04

(52) U.S. Cl. CPC H04W 72/085; H04W 72/048; H04W 88/08

(57) ABSTRACT

A plurality of MTC devices can connect to a base station device efficiently. The base station device allocates first radio resource for allowing transmission of data to, among MTC devices in a predetermined group that transmit data to the base station device using a common application data format, communication devices having a path loss less than a threshold for notification information transmitted from the base station device. The base station device allocates second radio resource for allowing transmission of data to communication devices having the path loss equal to or greater than the threshold. The communication devices having the path loss less than the threshold transmit the data to the base station device using the first radio resource. Each of the communication devices having the path loss equal to or greater than the threshold transmit the data to the base station device using the second radio resource.

### TECHNICAL FIELD

The present invention relates to a wireless communication system and more specifically to a wireless communication system including a plurality of communication devices performing machine communication.

### BACKGROUND ART

Conventionally, public wireless communication systems such as LTE (Long Term Evolution) can provide a variety of services to users through packet access. In such public wireless communication systems, the required information rate, delay, and others vary among services. The public wireless communication systems therefore prepare a plurality of classes depending on QoS (Quality of Service) and set a proper bearer for each service. FIG. 20 is a diagram illustrating classification in LTE. Referring to FIG. 20, nine classes are prepared in LTE.

The field of MTC (Machine Type Communication) has recently attracted attention, in which machines perform communication (machine communication) with each other without involving user's operation. MTC finds a wide variety of applications including security, medical care, agriculture, factory automation, and life line control. Among the applications of MTC, in particular, smart grids have attracted attention, which allow efficient transmission and distribution of energy by integrating, for example, information of electric power measured by a measurer called a smart meter, as illustrated in Non PTD 1 below.

Communications between MTC devices and between an MTC server managing MTC devices and an MTC device are expected to increasingly grow in the future. At present, as described in NPD 2, studies have been carried out to apply a system using a 3GPP (Third Generation Partnership Project) network such as LTE or a system using a short-range communication system in accordance with the IEEE 802.15 standard, to such communications.

MTC involves an extremely large number of devices and thus may require an enormous amount of control signals. In this respect, NPD 2 below proposes a grouping-based MTC management method. In this MTC management method, MTC devices that require various QoS are grouped according to permissible values of QoS, and AGTI (Access Grant Time Interval) corresponding to each group is allocated to each MTC device.

As a communication system for MTC devices, for example, the IDMA (Interleave Division Multiple Access) system is drawing attention, as described in NPD 3. According to NPD 3, the advantages of using the IDMA system in MTC communications include eliminating the need for scheduling and effectively applying a multi user interference canceller.

The signal receiving and demodulating processing in the IDMA system will be described below. For a channel in mobile communication, it is particularly effective to use a system called OFDM-IDMA, which uses IDMA and OFDM (Orthogonal Frequency Division Multiplexing) in combination. NPD 4 below explains the principle of the OFDM-IDMA. FIG. 21 is a diagram illustrating the principle of the OFDM-IDMA.

Referring to FIG. 21, each MTC device of each user encodes data to be transmitted with an encoder. Each MTC device then interleaves the encoded data with an interleaver. Each MTC device then modulates the interleaved signal. Each MTC device then performs inverse discrete Fourier transform of the modulated signal. A transmission signal is thus generated in each MTC device. An encoder common to the MTC devices is used. An interleaver different among devices is used.

The signal input to the antenna of a base station device is a mixture of signals from a plurality of MTC devices. The signal input to the antenna of the base station device additionally includes noise and interference. The base station device performs discrete Fourier transform of the signal. The base station device then performs MUD (Multi User Detection) on the signal obtained by discrete Fourier transform. The base station device thus separates the received signal into signals of individual users. MUD extracts a signal component of each user from the signal including a mixture of signals from a plurality of users. MUD adopts a method of gradually reducing interference components through iterative processing for the IDMA signal.

FIG. 22 is a diagram illustrating the operation of MUD. Referring to FIG. 22, the signal DFT-processed in the base station device is sent to an ESE (Elementary Signal Estimator). The ESE obtains the mean and variance for each bit, using Gaussian approximation. The ESE sends the means and variance to a deinterleaver corresponding to the interleaver of each user. The deinterleaver sends the deinterleaved signal (output) to an APP (A Posteriori Probability) decoder. The APP decoder performs decoding of a received sequence of log-likelihoods of channel bits, outputs the decoding result as a decoded signal for each user, and encodes it again for output to the interleaver with improved accuracy of the log-likelihood information. The ESE re-calculates the mean and variance based on the likelihood information of the transmission signal of each user that is sent from each APP decoder. MUD iteratively performs the processing above to increase the accuracy of signal estimation.

Japanese Patent Laying-Open No. 2007-60212 (PTD 1) discloses a configuration using a relay (relay device, repeater) that relays transmission data in uplink communication between a base station device and a portable terminal device.

NPD 5 below describes global standardization trends of cellular technology applied to machine communication.

### CITATION LIST

### Patent Document

PTD 1: Japanese Patent Laying-Open No. 2007-60212

### Non Patent Document

NPD 1: Tominaga et al., Smart Grid from the Viewpoint of ICT [II], the Journal of Institute of Electronics, Information and Communication Engineers, Vol. 95, No. 1, 2012
NPD 2: Shao-Yu Lien et al., Toward Ubiquitous Massive Accesses in 3GPP Machine-to-Machine Communications, IEEE Communications Magazine, April 2011
NPD 3: RCS2011-342: Matsumoto et al., Performance Evaluation of IDMA for Small Packet Transmission
NPD 4: Li Ping et al., The OFDM-IDMA Approach to Wireless Communication Systems, IEEE Wireless Communications, June 2007
NPD 5: Standardization Activity on Cellular-Based Machine-to-Machine Communication [online] [searched on Oct. 3, 2012] <URL: http://panasonic.co.jp/ptj/v5701/pdf/p0206.pdf>

### SUMMARY OF INVENTION

### Technical Problem

However, the MTC management method of NPD 2 requires that individual MTC devices should make connection requests. This MTC management method therefore is unable to reduce control signals in relation with the connection requests. In the MTC management method, connection is denied if the system does not satisfy the permissible value of an MTC device. This MTC management method hence cannot satisfy the need for connecting a large number of MTC devices.

The method of NPD 3 eliminates the procedure for access requests. The base station device therefore does not know which MTC device transmits. Therefore, in the actual situation, the base station device has to perform the reception processing on the assumption of signals from MTC devices that do not transmit data. Specifically, in order to perform the reception processing for a signal actually not transmitted, the base station device has to generate a variable value for computation processing, in consideration of the component of a signal actually not transmitted. An error is then produced in an earlier stage of the iterative processing of MUD. As described above, in MUD of the base station device, unnecessary computation occurs and the reception performance may be degraded.

The present invention is made in view of the problems described above and aims to provide a wireless communication system in which a plurality of communication devices (MTC devices) performing machine communication can efficiently connect to a base station device.

### Solution to Problem

(1) According to an aspect of the present invention, a wireless communication system includes a plurality of communication devices each performing machine communication and a base station device performing wireless communication with the plurality of communication devices. The plurality of communication devices are divided into communication devices in a first group that can transmit data to the base station device using a first application data format and communication devices in a second group that transmit data to the base station device using a second application data format. The base station device includes an allocation unit for allocating first radio resource for allowing transmission of the data to, of the communication devices in the first group, each of communication devices having a path loss less than a threshold for a predetermined signal transmitted from the base station device, and for allocating second radio resource for allowing transmission of the data to each of communication devices having the path loss equal to or greater than the threshold. Each of the communication devices having the path loss less than the threshold includes a first transmission unit for transmitting the data using the first radio resource to the base station device. Each of the communication devices having the path loss equal to or greater than the threshold includes a second transmission unit for transmitting the data using the first radio resource to the base station device.

(2) Preferably, the base station device transmits a transmission intensity of the predetermined signal and the threshold for the path loss to each of the communication devices in the first group. Each of the communication devices in the first group determines whether the path loss is less than the threshold, using a reception intensity and the transmission intensity of the predetermined signal.

(3) Preferably, each of the communication devices in the first group transmits the data to the base station device after transmitting to the base station device a request signal for requesting access to the base station device. The allocation unit allocates third radio resource for allowing transmission of the request signal, to each of the communication devices having the path loss less than the threshold, and allocates fourth radio resource for allowing transmission of the request signal, to each of the communication device having the path loss equal to or greater than the threshold.

(4) According to another aspect of the present invention, a wireless communication system includes a plurality of communication devices each performing machine communication and a base station device performing wireless communication with the plurality of communication devices. The plurality of communication devices are divided into communication devices in a first group that transmit data to the base station device using a first application data format and communication devices in a second group that transmit data to the base station device using a second application data format. The base station device includes an allocation unit for allocating first radio resource for allowing transmission of the data to, of the communication devices in the first group, each of communication devices having a distance from the base station device less than a threshold, and for allocating second radio resource for allowing transmission of the data to each of communication devices having the distance equal to or greater than the threshold. Each of the communication devices having the distance less than the threshold includes a first transmission unit for transmitting the data using the first radio resource to the base station device. Each of the communication devices having the distance equal to or greater than the threshold includes a second transmission unit for transmitting the data using the first radio resource to the base station device.

(5) Preferably, each of the communication devices in the first group transmits, to the base station device, a request signal for requesting access to the base station and positional information representing a position of the communication device, before transmitting the data. The base station device further includes a calculation unit for calculating, for each of the communication devices in the first group, a distance between the communication device and the base station device, based on the positional information. The allocation unit allocates the first radio resource or the second radio resource to each of the communication devices in the first group, based on the calculated distance.

(6) Preferably, the wireless communication system further includes a control device that controls the plurality of communication devices through the base station device. A common first group identifier is set for each of the communication devices in the first group. A common second identifier is set for each of the communication devices in the second group. One of the base station device and the control device allocates the first radio resource or the second radio resource to each of the communication devices having the first group identifier, based on the path loss (or the distance).

(7) Preferably, each of first control information transmitted from the base station device and including allocation information indicating allocation of the first radio resource and second control information transmitted from the base station device and including allocation information indicating allocation of the second radio resource further includes a plurality of device identifiers for identifying communication devices.

(8) Preferably, the first control information includes a common signal format used by each of the communication devices having the path loss less than the threshold. The second control information includes a common signal format used by each of the communication devices having the path loss equal to or greater than the threshold.

(9) Preferably, the data transmitted by each of the communication devices in the first group is data based on an interleave division multiple access that is generated with an interleave pattern different for each communication device.

(10) Preferably, in the first application data format, a block size of data is defined at a predetermined value.

(11) Preferably, each of the communication devices in the first group has a predetermined first function. Each of the communication devices in the second group has a predetermined second function.

### Advantageous Effects of Invention

According to the configuration above, a plurality of communication devices (MTC devices) that perform machine communication can connect to a base station device efficiently.

### BRIEF DESCRIPTION OF DRAWINGS

FIG. 1 is a diagram illustrating a schematic configuration of wireless communication system 1.

FIG. 2 is a diagram illustrating grouping of MTC devices 100A to 100H.

FIG. 3 is a diagram schematically illustrating a hardware configuration of MTC device 100.

FIG. 4 is a diagram illustrating a typical hardware configuration of base station device 200.

FIG. 5 is a diagram illustrating main grouping of MTC devices 100.

FIG. 6 is a diagram illustrating an example of an access request acceptance segment.

FIG. 7 is a diagram illustrating a format of resource allocation information included in an access enable signal (control information).

FIG. 8 is a diagram illustrating an example of the allocated resource.

FIG. 9 is a diagram illustrating a data format of an application for use in MTC devices 100E to 100H (monitoring cameras) in subgroup A.

FIG. 10 is a diagram illustrating a data format of an application for use in MTC devices 100A to 100D (electric meters) in subgroup B.

FIG. 11 is a diagram illustrating a functional configuration of MTC device 100 and a functional configuration of base station device 200.

FIG. 12 is a sequence chart illustrating the procedure of the processing in wireless communication system 1.

FIG. 13 is a diagram illustrating a schematic configuration of wireless communication system 1′.

FIG. 14 is a diagram schematically illustrating a hardware configuration of MTC device 100′.

FIG. 15 is a diagram illustrating an example of the access request acceptance segment.

FIG. 16 is a diagram illustrating a format 8 of resource allocation information.

FIG. 17 is a diagram illustrating an example of the allocated resource.

FIG. 18 is a diagram illustrating a functional configuration of MTC devices 100A′ to 100D′ and a functional configuration of base station device 200′.

FIG. 19 is a sequence chart illustrating the procedure of the processing in wireless communication system 1′.

FIG. 20 is a diagram illustrating classification in LTE.

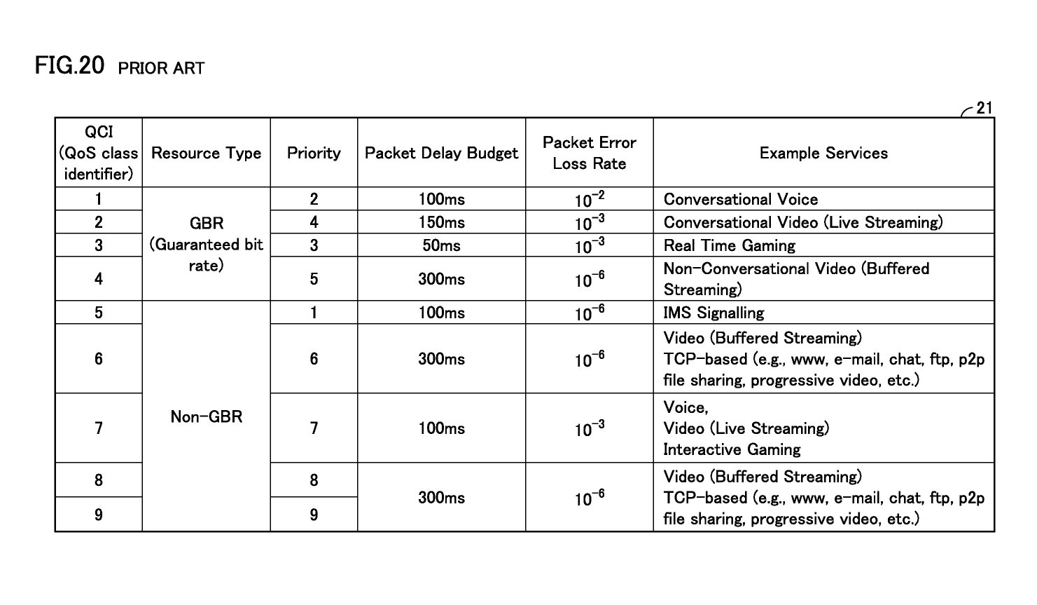

FIG. 21 is a diagram illustrating the principle of the OFDM-IDMA.

FIG. 22 is a diagram illustrating the operation of MUD.

### DESCRIPTION OF EMBODIMENTS

A communication system according to embodiments of the present invention will be described below with reference to the figures. In the following description, the same parts are denoted with the same reference signs. The designations and functions thereof are also the same. A detailed description thereof is not repeated.

### First Embodiment

<A. System Configuration>

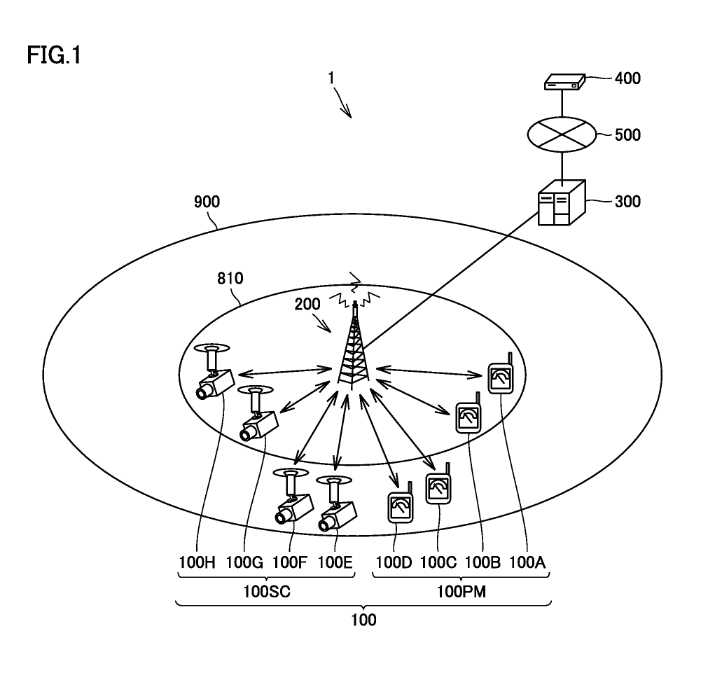

FIG. 1 is a diagram illustrating a schematic configuration of a wireless communication system 1. Referring to FIG. 1, wireless communication system 1 includes a plurality of MTC devices 100A to 100H, a base station device (eNB: evolved Node B) 200, an MME (Mobile Management Entity) 300, and a server device 400.

Base station device 200 forms a cell 900. MTC devices 100A to 100H reside in cell 900 in which they can communication with base station device 200. MTC devices 100A, 100B, 100G, 100H reside in an area 810 including a position where base station device 200 is installed. MTC devices 100C to 100F reside outside of area 810. Area 810, which will be described later, is an area in which a path loss (transmission loss) in communication with base station device 200 is less than a threshold Th1.

Base station device 200 is connected to be able to communicate with MME 300. MME 300 is connected to be able to communicate with server device 400 through a network (a mobile communication network and/or the Internet) 500.

MTC devices 100A to 100H are communication devices that perform machine communication. Here, the “communication device that performs machine communication” means a communication device that automatically transmits or receives data in a predetermined format (or type).

MTC devices 100E to 100H are monitoring cameras. MTC devices 100A to 100D are electric meters (smart meters (registered trademark)). MTC devices 100A to 100H each have a communication function. MTC devices 100A to 100H each communicate with base station device 200. Data (image data or measurement data) transmitted from each of MTC devices 100A to 100H is transmitted to server device 400 through base station device 200 and MME 300.

MME 300 mainly executes mobility management of mobile station devices (UE: User Equipment), session management, non-access layer signaling and security, alarm message transmission, and selection of a base station device matched with an alarm message. According to an aspect, MME 300 controls the mobile station devices through base station device 200, as described above.

In the following description, a single MTC device is referred to as “MTC device 100” without differentiating MTC devices 100A to 100H, for convenience of explanation. A single MTC device is referred to as “MTC device 100PM” without differentiating MTC devices 100A to 100D. A single MTC device is referred to as “MTC device 100SC” without differentiating MTC devices 100E to 100H.

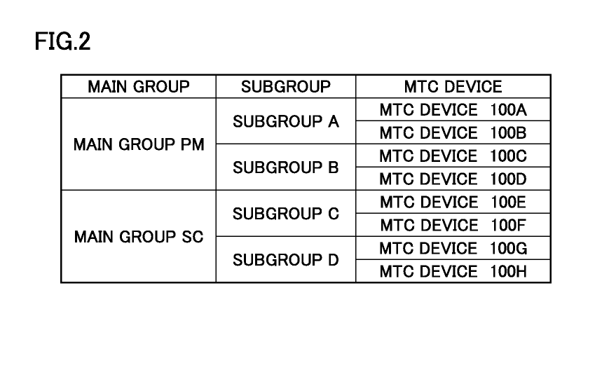

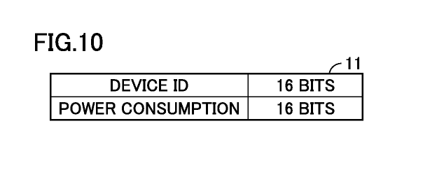

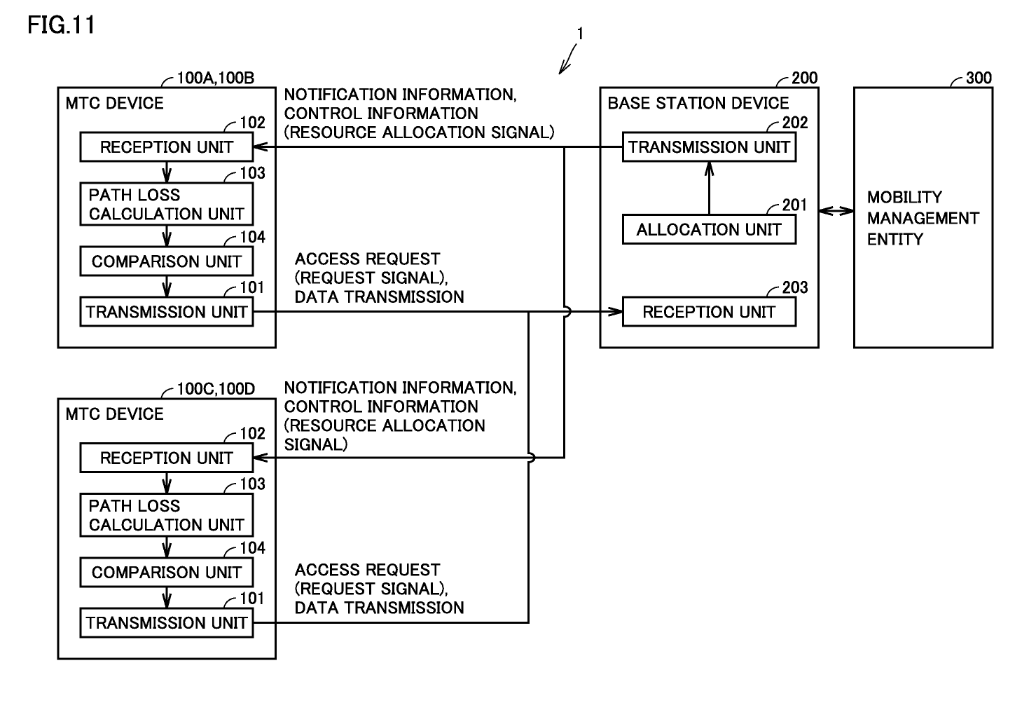

FIG. 2 is a diagram illustrating grouping of MTC devices 100A to 100H. Referring to FIG. 2, in wireless communication system 1, MTC devices 100A to 100H are grouped such that at least the block size of data transmitted by each of MTC devices 100A to 100H is common That is, they are grouped according to the difference in application data format (for example, FIGS. 10 and 11) in which data is transmitted to base station device 200. Specifically, in wireless communication system 1, as classification of main groups, MTC devices 100A to 100D having a common function are classified into a main group PM and MTC devices 100E to 100H having a common function are classified into a main group SC.

Wireless communication system 1 is configured such that the traffic distribution of MTC devices is common in the same group. Specifically, main group PM is divided into a subgroup A having a path loss less than the threshold and a subgroup B having a path loss equal to or greater than threshold Th1. Main group SC is also divided into a subgroup C having a path loss less than threshold Th1 and a subgroup D having a path loss equal to or greater than threshold Th1.

Subgroup A includes MTC devices 100A, 100B. Main group SC includes MTC devices 100C, 100D. Subgroup C includes MTC devices 100E, 100F. Subgroup D includes MTC devices 100G, 100H.

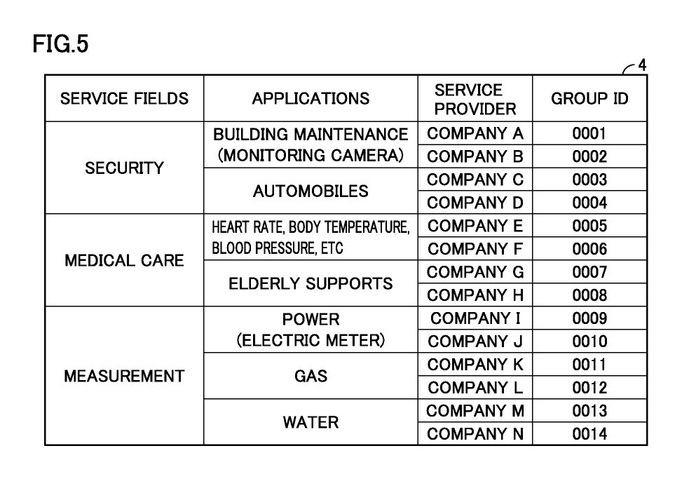

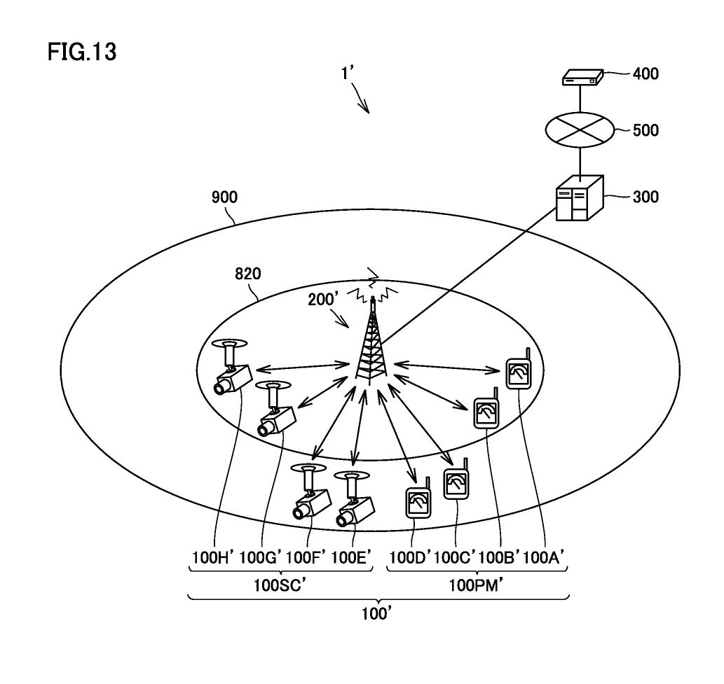

Whether the path loss is less than threshold Th1 is determined by each of MTC devices 100A to 100H (FIG. 13). MTC devices 100A to 100H each store threshold Th1 in advance. Which MTC device belongs to which main group PM or SC is specified by a group ID described later (FIG. 5).

The following description is mainly focused on MTC devices 100A to 100D (that is, MTC devices 100PM) in main group PM, for convenience of explanation. The same processing as in MTC devices 100A to 100D in main group PM is performed in MTC devices 100E to 100H (that is, MTC devices 100SC) in main group SC. A detailed description of the processing in MTC devices 100E to 100H in main group SC is therefore not repeated.

<B. Process Overview>

An overview of the processing performed in wireless communication system 1 will be described below.

Base station device 200 or MME 300 sets a different access request acceptance segment for each of main groups (main groups PM, SC). More specifically, base station device 200 or MME 300 sets a different access request acceptance segment for each of subgroup A, subgroup B, subgroup C, and subgroup D.

For example, base station device 200 or MME 300 sets an access request acceptance segment PA for subgroup A and sets an access request acceptance segment PB for subgroup B in main group PM. Wireless communication system 1 may be configured such that an entity (not shown) other than base station device 200 and MME 300 sets an access request acceptance segment.

The access request acceptance segment refers to radio resource that can be used in the uplink of wireless communication system 1. Specifically, the access request acceptance segment is configured with a plurality of successive resource blocks. For example, base station device 200 or MME 300 allocates radio resource RqA (third radio resource) common in subgroup A to each of MTC devices 100A, 100B in subgroup A and allocates radio resource RqB (fourth radio resource) common in subgroup B to each of MTC devices 100C, 100D in subgroup B. The details of the access request acceptance segment will be described later.

MTC devices 100A to 100D each transmit an access request signal in a predetermined signal format to base station device 200 in the access request acceptance segment set for each subgroup. In other words, MTC devices 100A to 100D each transmit an access request signal to base station device 200 using radio resource RqA, RqB allocated thereto.

Base station device 200 receives the access request signal. Base station device 200 transmits an access enable signal corresponding to the access request signal collectively to MTC devices 100A to 100D. Specifically, base station device 200 allocates radio resource DtA (first radio resource) common in subgroup A to each of MTC devices 100A, 100B in subgroup A having a path loss less than threshold Th1 and allocates radio resource DtB (second radio resource) common in subgroup B to each of MTC devices 100C, 100D in subgroup B having a path loss equal to or greater than threshold Th1.

Base station device 200 transmits an access enable signal (control information C1) including resource allocation information indicating the allocation of radio resource DtA to each of MTC devices 100A, 100B in subgroup A, and transmits an access enable signal (control information C2) including resource allocation information indicating the allocation of radio resource DtB to each of MTC devices 100C, 100D in subgroup B.

MTC devices 100A to 100D each transmit data to base station device 200 using a predetermined signal format, in accordance with the resource allocation information included in the access enable signal. Specifically, MTC devices 100A, 100B in subgroup A transmit data to base station device 200 using radio resource DtA. MTC devices 100C, 100D in subgroup B transmit data to base station device 200 using radio resource DtB.

Base station device 200 simultaneously receives data from a plurality of MTC devices 100A to 100D, using the multi user detection (MUD) technique.

As described above, in wireless communication system 1, it is assumed that a plurality of MTC devices 100 (for example, MTC devices 100A, 100B, 100E, 100F) that transmit data to base station device 200 using different application data formats are grouped (for example, subgroups A, C) so that access request, resource allocation, and data transmission are collectively performed (hereinafter referred to as “configuration A”). In wireless communication system 1, a plurality of MTC devices 100A to 100D that transmit data to base station device 200 using a common application data format are grouped (subgroups A, B) so that access request, resource allocation, and data transmission are collectively performed (hereinafter referred to as “configuration B”).

Compared with a configuration without grouping, configuration A enables more MTC devices 100 to efficiently connect to a network (base station device 200, MME 300, server device 400) in wireless communication system 1.

Configuration B enables base station device 200 to receive signals of equivalent quality from MTC devices receiving in the same access request acceptance segment. Accordingly, in radio resource allocation, MCSs (Modulation and Coding Scheme) different among groups can be set even for MTC devices using a common application data format. Specifically, base station device 200 can set a high code rate for subgroup A near base station device 200 and set a low code rate for subgroup B far from base station device 200.

Radio resource thus can be used more efficiently compared with a configuration in which a plurality of MTC devices 100A to 100H that transmit data to base station device 200 using different application data formats are simply grouped (main groups PM, SC) so that access request, resource allocation, and data transmission are collectively performed (that is, a configuration without subgroup classification). That is, not only main groups but also subgroups are formed (FIG. 2) to enable more MTC devices 100 to efficiently connect to the network, because MTC devices having a common data configuration or traffic distribution can be handled as the same group.

In the following, a configuration in which base station device 200 sets an access request acceptance segment for each of a plurality of subgroups A, B will be described by way of example, for convenience of explanation.

<C. Hardware Configuration>

(c1. MTC Device 100)

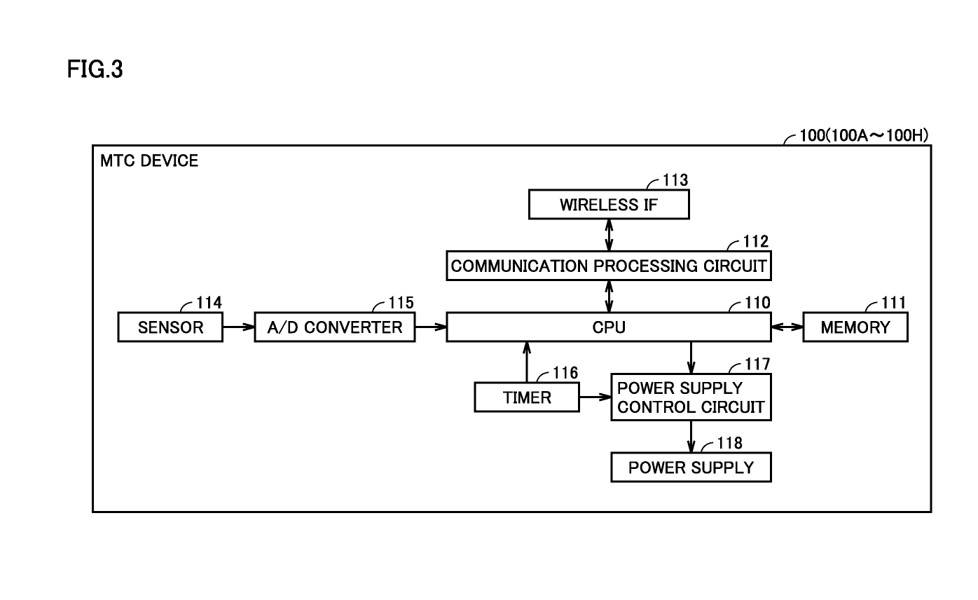

FIG. 3 is a diagram illustrating an overview of a hardware configuration of MTC device 100. Referring to FIG. 3, MTC device 100 includes a CPU (Central Processing Unit) 110, a memory 111, a communication processing circuit 112, a wireless IF 113, a sensor 114, an A/D (Analog to Digital) converter 115, a timer 116, a power supply control circuit 117, and a power supply 118.

When a start instruction signal is input from power supply control circuit 117, CPU 110 reads out a program stored in memory 111. CPU 110 runs the read program to control the entire operation of MTC device 100. CPU 110 reads out an equipment identifier (device ID) and an MTC group identifier (group ID) stored in advance from memory 111. CPU 110 extracts information corresponding to the access request acceptance segment corresponding to the group ID from the received information from base station device 200 that is input from communication processing circuit 112. CPU 110 stores the extracted information corresponding to the access request acceptance segment into memory 111. CPU 110 generates schedule information corresponding to the access request acceptance segment and sets the same in power supply control circuit 117.

CPU 110 temporarily stores digital data input from A/D converter 115 into memory 111. CPU 110 generates an access request signal corresponding to the access request acceptance segment. CPU 110 outputs the generated access request signal, as a signal to be transmitted to base station device 200, to communication processing circuit 112. CPU 110 generates a signal for transmitting the digital data temporarily stored in memory 111 to base station device 200, in response to the access enable signal from the base station that is input from communication processing circuit 112. CPU 110 outputs the generated signal to communication processing circuit 112. When a stop instruction signal is input from power supply control circuit 117, CPU 110 stops the operation of the running program thereby to stop the operation of units other than timer 116 and power supply control circuit 117.

Communication processing circuit 112 processes a signal in a base frequency band input from wireless IF 113 (received signal) to generate an information signal sequence or a control information sequence. Communication processing circuit 112 outputs the generated sequence to CPU 110. Communication processing circuit 112 outputs the signal input from CPU 110, as a signal in a base frequency band to be transmitted to base station device 200, to wireless IF 113.

Wireless IF 113 down-converts the signal received via radio waves from base station device 200 to generate a signal in a base frequency band. Wireless IF 113 outputs the generated signal in a base frequency band to communication processing circuit 112. Wireless IF 113 up-converts the signal in a base frequency band input from communication processing circuit 112 to generate a signal in a radio frequency band. Wireless IF 113 outputs the generated signal in a radio frequency region, with power amplified, to base station device 200 via radio waves.

Sensor 114 senses analog data representing the surrounding environment of MTC device 100. Sensor 114 is, for example, a camera capturing an image or an electric power sensor including a voltmeter and an ammeter for measuring electric power. Sensor 114 outputs the sensed analog data to A/D converter 115.

A/D converter 115 performs A/D conversion of the analog data input from sensor 114 to generate digital data. A/D converter 115 outputs the generated digital data to CPU 110.

Timer 116 sequentially measures the present time and outputs the measured time information to CPU 110 and power supply control circuit 117.

In power supply control circuit 117, scheduling information is preset, which represents information about the start time to start power supply 118 and the stop time to stop power supply 118. It is noted that “stop” means a state in which timer 116 and power supply control circuit 117 operate while the other functional units stop. Power supply control circuit 117 generates a start instruction to start when the time information input from timer 116 reaches the start time represented by the scheduling information corresponding to the time information. Power supply control circuit 117 generates a stop instruction signal to stop when the time information input from timer 116 reaches the stop time represented by the scheduling information corresponding to the time information. Power supply control circuit 117 outputs the generated start instruction signal or stop instruction signal to CPU 110 and power supply 118.

Power supply 118 supplies power to each unit in MTC device 100 when a start instruction signal is input from power supply control circuit 117. Power supply 118 stops supply of power supply 118 to each unit other than timer 116 and power supply control circuit 117 after a stop instruction signal is input from power supply control circuit 117 and the operation of CPU 110 stops.

The processing in MTC device 100 is implemented by hardware and software executed by CPU 110. Such software may be stored in memory 111 in advance. The software may be stored in memory cards or other storage media and distributed as program products. Otherwise, the software may be provided as downloadable program products by an information provider connected to the Internet. Such software is read out from the storage medium by an IC card reader/writer or other reading devices or downloaded via wireless IF 113 and then temporarily stored into memory 111. The software is read out from memory 111 by CPU 110 and stored in the form of an executable program into memory 111. CPU 110 executes the program.

Each component included in MTC device 100 shown in the figure is the general one. It can be said that the essential part of the present invention is the software stored in memory 111, a memory card, or other storage media or software downloadable via a network.

The recording medium is not limited to a DVD-ROM, a CD-ROM, an FD, and a hard disk but may be a medium that fixedly carries the program, such as a magnetic tape, a cassette tape, an optical disk, an optical card, and a semiconductor memory such as a mask ROM, an EPROM, an EEPROM, and a flash ROM. The recording medium is a non-transitory medium having the program or other data readable by a computer. The program referred to here includes not only a program directly executable by a CPU but also a program in a source program format, a compressed program, and an encrypted program.

(c2. Base Station Device 200)

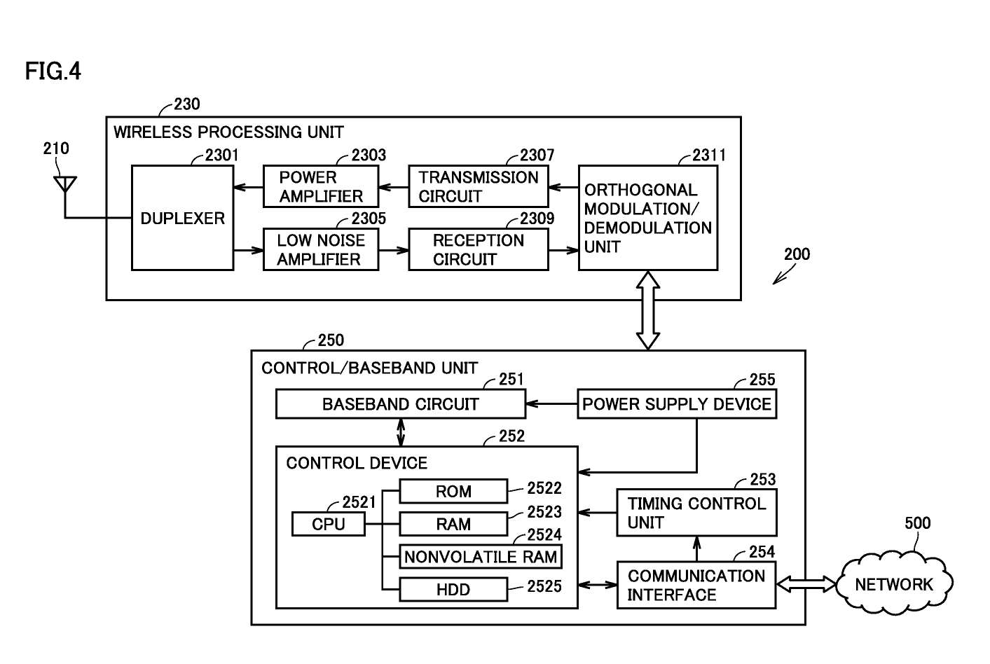

FIG. 4 is a diagram illustrating a typical hardware configuration of base station device 200. Referring to FIG. 4, base station device 200 includes an antenna 210, a wireless processing unit 230, and a control/baseband unit 250.

Wireless processing unit 230 includes a duplexer 2301, a power amplifier 2303, a low noise amplifier 2305, a transmission circuit 2307, a reception circuit 2309, and an orthogonal modulation/demodulation unit 2311. Control/baseband unit 250 includes a baseband circuit 251, a control device 252, a power supply device 255, a timing control unit 253, and a communication interface 254. Control device 252 includes a CPU 2521, a ROM 2522, a RAM 2523, a nonvolatile memory 2524, and an HDD (Hard Disk Drive) 2525.

Orthogonal modulation/demodulation unit 2311 orthogonally modulates/demodulates an OFDM (Orthogonal Frequency Division Multiplexing) signal processed by baseband circuit 251 for conversion into an analog signal (RF (Radio Frequency) signal). Transmission circuit 2307 converts the RF signal generated by orthogonal modulation/demodulation unit 2311 into a frequency to be sent as a radio wave. Reception circuit 2309 converts the received radio wave into a frequency to be processed by orthogonal modulation/demodulation unit 2311.

Power amplifier 2303 amplifies power of the RF signal generated by transmission circuit 2307 for transmission from antenna 210. Low noise amplifier 2305 amplifies a weak radio wave received by antenna 210 and passes the amplified radio wave to reception circuit 2309.

Control device 252 performs control of the entire base station device 200 and protocol or control monitoring for call control. Timing control unit 253 generates a variety of clocks for use in the inside of base station device 200, based on a reference clock extracted from, for example, a transmission path.

Communication interface 254 connects a transmission path such as Ethernet (registered trademark) and processes a protocol such as IPsec (Security Architecture for Internet Protocol) and IPv6 (Internet Protocol Version 6) to exchange IP packets.

Baseband circuit 251 performs conversion (modulation/demodulation) of an IP packet exchanged using communication interface 254 and an OFDM signal (baseband signal) carried on a radio wave. The baseband signal is exchanged with wireless processing unit 230.

Power supply device 255 converts the voltage supplied to base station device 200 into a voltage used in the inside of base station device 200.

The processing in base station device 200 is implemented by hardware and software executed by CPU 2521. Such software may be stored in, for example, HDD 2525 in advance. The software may be stored in memory cards (not shown) or other storage media and distributed as program products. Otherwise, the software may be provided as downloadable program products by an information provider connected to the Internet. Such software is read out from the storage medium by an IC card reader/writer or other reading devices or downloaded via communication interface 254 and then temporarily stored into HDD 2525. The software is read out from HDD 2525 by CPU 2521 and then stored in the form of an executable program into nonvolatile memory 2524. CPU 2521 executes the program.

Each component included in base station device 200 shown in the figure is the general one. It can be said that the essential part of the present invention is the software stored in HDD 2525, nonvolatile memory 2524, a memory card, or other storage medium or software downloadable via a network. The operation of the hardware of base station device 200 is well known and a detailed description thereof is not repeated.

The recording medium is not limited to a DVD-ROM, a CD-ROM, an FD (Flexible Disk), and a hard disk but may be a medium that fixedly carries the program, such as a magnetic tape, a cassette tape, an optical disk (MO (Magnetic Optical Disc)/MD (Mini Disc)/DVD (Digital Versatile Disc)), an optical card, and a semiconductor memory such as a mask ROM, an EPROM (Electronically Programmable Read-Only Memory), an EEPROM (Electronically Erasable Programmable Read-Only Memory), and a flash ROM. The recording medium is a computer-readable non-transitory medium. The program referred to here includes not only a program directly executable by a CPU but also a program in a source program format, a compressed program, and an encrypted program.

<D. Details of Processing>

The details of the processing performed in wireless communication system 1 will now be described.

FIG. 5 is a diagram illustrating main grouping of MTC devices 100. As described above, MTC devices having a common function (characteristic) are classified into the same group.

Referring to FIG. 5, in a data table 4, service fields, applications, and service providers are associated with group IDs representing groups. Data table 4 is stored in base station device 200 or MME 300. Examples of the service fields include security, medical care, and measurement fields. Examples of the applications include applications used in the fields of building maintenance, automobiles, human body status measurement (heart rate, body temperature, blood pressure, etc.), elderly supports, electric power, gas, water, and the like.

For example, in the application for building maintenance with a monitoring camera having a group ID “0001” (corresponding to “subgroups C, D”), video of the monitoring camera (MTC devices 100E to 100H) is successively transmitted at 300 kbps. For example, MTC devices 100E to 100H are monitoring cameras of Company A. MTC devices 100E to 100H transmit a data block of 300 kbit once a second to base station device 200 in order to enhance the communication efficiency while permitting a delay.

In the application of power consumption measurement with an electric meter having a group ID “0009” (corresponding to “subgroups A, B”), the electric meter (MTC devices 100A to 100D) transmits a data block of 32 bits once an hour. For example, MTC devices 100A to 100D are monitoring cameras of Company I.

Each MTC device 100 receives allocation of a group ID from MME 300 through position registration processing. The communication for the position registration is not bound to the access request acceptance segment below. Alternatively, an ID set in advance in a memory (for example, a ROM (Read Only Memory) or a USIM (Universal Subscriber Identification Module)) may be used as a group ID.

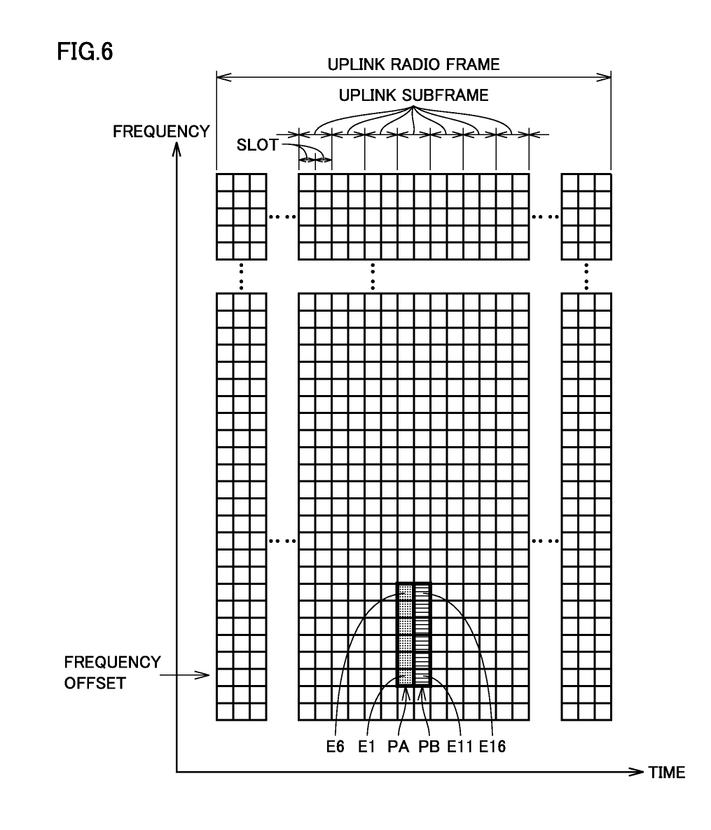

FIG. 6 is a diagram illustrating an example of the access request acceptance segment. Specifically, FIG. 6 illustrates access request acceptance segment PA allocated to subgroup A and access request acceptance segment PB allocated to subgroup B.

MTC devices 100A to 100D determine access request acceptance segments PA, PB, based on the number of the frame, the number of the uplink subframe, and the frequency offset corresponding to main group PM. MTC devices 100A to 100D select access request acceptance segment PA if the path loss is less than threshold Th1, and selects access request acceptance segment PB if the path loss is equal to or greater than threshold Th1.

Referring to FIG. 6, MTC devices 100A, 100B in subgroup A transmit an access request to base station device 200 in the selected access request acceptance segment PA. Access request acceptance segment PA is configured with six resource blocks in succession in the frequency direction, in a predetermined subframe (uplink subframe) in one frame. Specifically, access request acceptance segment PA is a segment defined by a resource block E1 and a resource block E6.

MTC devices 100C, 100D in subgroup B transmit an access request to base station device 200 in the selected access request acceptance segment PB. Access request acceptance segment PB is configured with six resource blocks in succession in the frequency direction, in a predetermined subframe in one frame, in the same manner as access request acceptance segment PB. Specifically, access request acceptance segment PB is a segment defined by a resource block E11 and a resource block E16. Access request acceptance segment PB is a segment shifted from access request acceptance segment PA in the time axis direction but may be segment shifted in the frequency axis direction rather than being shifted in the time axis direction.

In LTE, each of a plurality of uplink subframes is configured with two slots (uplink slots) adjacent in the time axis direction. Each slot includes a plurality of resource blocks in the frequency axis direction. Each resource block is configured with a region of 180 kHz×0.5 msec. Each resource block is configured with a plurality of resource elements (12 in the frequency axis direction and seven in the time axis direction, in total, 84 resource elements).

In this manner, MTC devices 100A, 100B in subgroup A each transmit data to base station device 200, using six resource blocks (radio resource) in succession in the frequency direction, in a predetermined subframe (uplink subframe) in one frame. MTC devices 100C, 100D in subgroup B each transmit data to base station device 200, using six resource blocks (radio resource) in succession in the frequency direction, in a predetermined subframe (uplink subframe) in one frame.

Since the number of the frame is repeated every 10 seconds or so, another parameter is necessary in order to increase the interval between segments. MTC devices 100A, 100B generate a sequence using a parameter provided by a root sequence index and performs shift processing corresponding to the device ID. MTC devices 100C, 100D perform shift processing in the same manner.

Base station device 200 receives access request signals transmitted from MTC devices 100. Base station device 200 identifies which MTC device 100 has transmitted the access request signal based on the received signal. By using a signal with high orthogonality as the access request signal, base station device 200 can receive access request signals simultaneously from a plurality of MTC devices 100.

Base station device 200 confirms that the received access request signals are the access request signals from devices in the designated main group. If the number of access request signals is equal to or smaller than a permissible number, base station device 200 transmits a control signal including resource allocation information (access enable, scheduling) to these MTC devices 100.

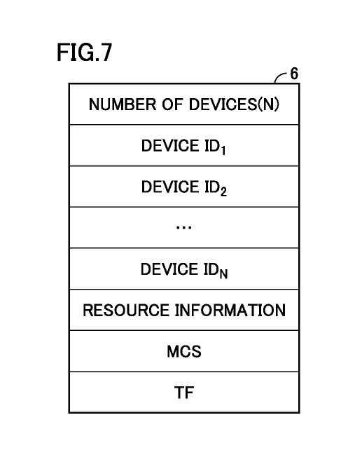

FIG. 7 is a diagram illustrating a format of the resource allocation information included in the access enable signal (control information). Referring to FIG. 7, with a format 6 of the resource allocation information, allocation to a plurality of devices can be announced using single resource allocation information. The number of devices N represents the number of MTC devices 100PM to which allocation is performed. The device ID (ID₁ to ID_{N}) indicates the ID of each MTC device 100PM. The resource information field includes information of the start position and the length of a resource block in the resource allocated. MCS indicates a combination of a modulation scheme and a code rate in transmission. TF (Transport Format) indicates a transmission format. Format 6 of the resource allocation information is prepared for each subgroup.

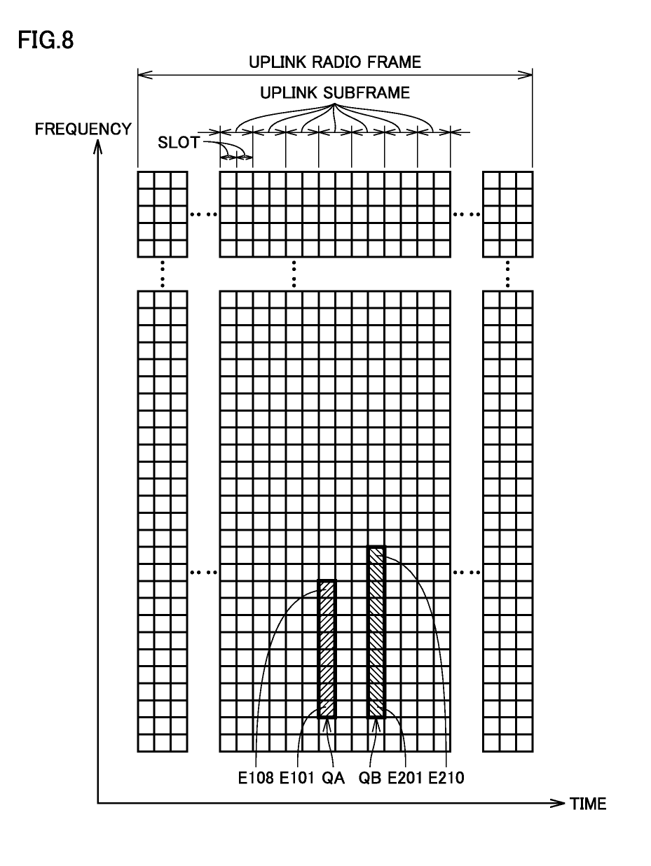

FIG. 8 is a diagram illustrating an example of the allocated resource. Referring to FIG. 8, N MTC devices 100PM belonging to the same subgroup share the resource block indicated by the resource information field. N MTC devices 100PM to which common resource is allocated use a common MCS and a common TF.

For example, MTC devices 100PM classified in subgroup A transmit data of the measured power consumption (hereinafter also referred to as “measurement data”) to base station device 200 using the common MCS and the common TF, in the allocated segment QA. The segment QA is configured with eight resource blocks in succession in the frequency direction, in a predetermined uplink subframe in one frame. Specifically, the segment QA is a segment defined by a resource block E101 and a resource block E108. In this case, MTC devices 100A, 100B in subgroup A each transmit video data to base station device 200, using eight resource blocks (radio resource) in succession in the frequency direction, in a predetermined uplink subframe in one frame.

MTC devices 100C, 100D in subgroup B transmit measurement data to base station device 200 using the common MCS and the common TF, in the allocated segment QB. The segment QB is configured with 10 resource blocks in succession in the frequency direction, in a predetermined uplink subframe in one frame. Specifically, the segment QB is a segment defined by a resource block E201 and a resource block E210. In this case, MTC devices 100C, 100D in subgroup B each transmit video data to base station device 200, using 10 resource blocks (radio resource) in succession in the frequency direction, in a predetermined uplink subframe in one frame.

As described above, each of MTC devices 100PM belonging to the same subgroup transmits video data in a common application data format to base station device 200, using common radio resource, a common MCS, and a common TF.

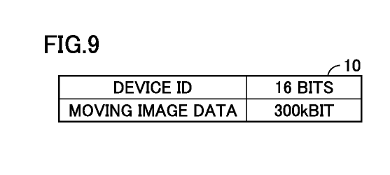

FIG. 9 is a diagram illustrating a data format of an application used in MTC devices 100E to 100H (monitoring cameras) in subgroup A. Referring to FIG. 9, MTC devices 100E to 100H transmit the captured video data to server device 400 through base station device 200 and MME 300, using a data format 10 for transmitting moving image data obtained by image capturing at 300 kbit.

FIG. 10 is a diagram illustrating a data format of an application used in MTC devices 100A to 100D (electric meters) in subgroup B. Referring to FIG. 10, MTC devices 100A to 100D transmit data obtained through measurement to server device 400 through base station device 200 and MME 300, using a data format 11 for transmission at 16 bits.

The data transmitted from an MTC device may include, in addition to the application data shown in FIG. 9 and FIG. 10, information such as an IP header including the preset device's own IP address and the IP address of the destination MTC server, and a TCP or UDP header including a port number.

When base station device 200 simultaneously allocates transmission for a plurality of MTC devices 100 in the same group, the lengths of signals simultaneously transmitted from MTC devices 100 are standardized. Allocating transmission data of different data lengths to a common TF is inefficient because padding is required. However, in this case, signals having a standardized data length are associated with a common TF, thereby enabling efficient transmission. Each MTC device generates a signal for transmission, using the device ID uniquely allocated to MTC device 100.

In wireless communication system 1, since a plurality of MTC devices 100 use common radio resource, the signals may collide and interfere with each other. There are some possible methods by which base station device 200 extracts data transmitted from each MTC device 100 while suppressing interference of signals from other MTC devices 100. In wireless communication system 1, the IDMA system described above is used as a method for extracting data.

According to NPD 3 above in connection with the IDMA system, a common MCS alone is announced to all the terminals in a cell, without performing scheduling, whereas in wireless communication system 1, scheduling of MTC devices 100 is performed in response to access request signals. The control information required for scheduling, however, is significantly small compared with the conventional method in which scheduling is performed for MTC devices one by one, because the scheduling can be sent collectively to a plurality of MTC devices 100.

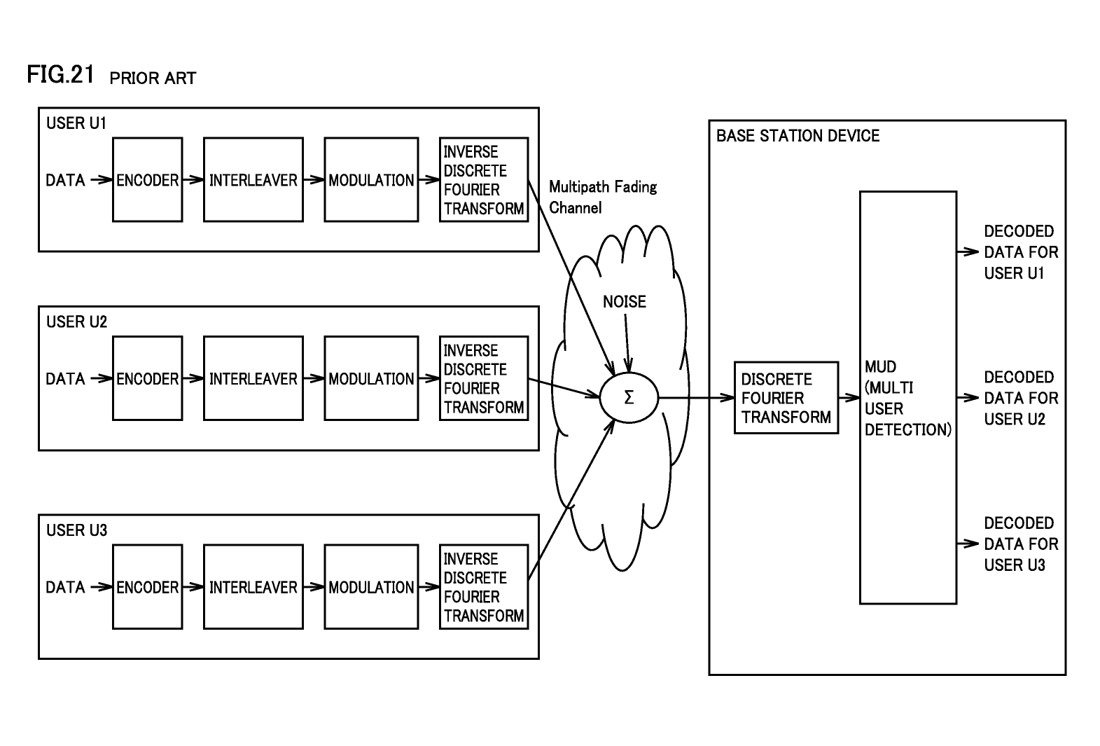

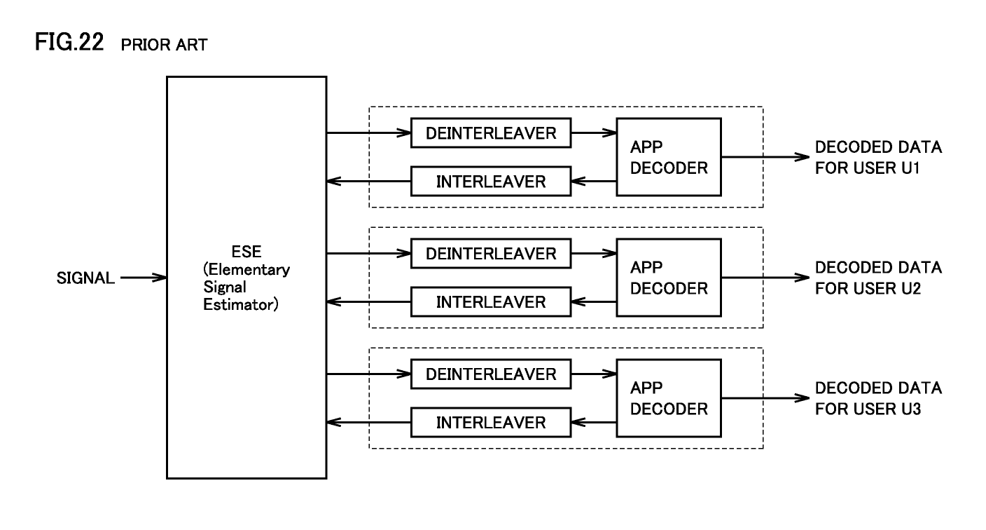

For the processing of receiving and demodulating an IDMA signal, the method described in conjunction with FIG. 21 and FIG. 22 is used. A repeated description is not given here.

When the iterative processing by MUD as described above for enhancing the accuracy of signal estimation is performed, it is important that data of MTC devices 100 is transmitted using common MCS and TF. If MTC devices 100 transmit data to base station device 200 using different MCSs and/or different TFs, the MUD processing in base station device 200 varies among MTC devices 100, and the allocation of the processing becomes complicated. With the standardized MCS and TF, base station device 200 easily performs the iterative processing of decoding the signals sent from MTC devices 100, in parallel. That is, in a case where MCSs and TFs cannot be standardized, the length of the interleaver in FIG. 22, the processing volume of the decoder, and the storage capacity vary, and in addition, the processing delay also varies. With the standardized MCS and TF, a common configuration of the deinterleaver, the APP decoder, and the interleaver for each user can be used, and it is only necessary to change interleave patterns. With the standardized MCS and TF, the processing delays become uniform, and base station device 200 easily parallelizes the decoding processing. Furthermore, with the standardized MCS and TF, base station device 200 no longer has to perform the processing such as quality measurement for determining the MCS and the TF, and notification of data volume.

<E. Functional Configuration>

FIG. 11 is a diagram illustrating a functional configuration of MTC device 100 and a functional configuration of base station device 200. In FIG. 11, of MTC devices 100A to 100H, only MTC devices 100A to 100D are illustrated for convenience of explanation. Referring to FIG. 11, MTC devices 100A to 100D each include a transmission unit 101, a reception unit 102, a path loss calculation unit 103, and a comparison unit 104. Base station device 200 includes an allocation unit 201, a transmission unit 202, and a reception unit 203.

(1) Allocation unit 201 of base station device 200 selectively prepares radio resource RqA (third radio resource) and radio resource RqB (fourth radio resource) used when MTC devices 100A to 100D make an access request, for each of MTC devices 100A to 100D in main group PM that transmit data to base station device 200 using a predetermined one application data format, among a plurality of MTC devices 100A to 100H.

Transmission unit 202 transmits notification information to each of MTC devices 100A to 100D. The notification information includes information representing allocation of the prepared radio, information representing threshold Th1 of the path loss, and information of transmission power for transmitting the notification information.

Each reception unit 102 of MTC devices 100A to 100D receives the notification information from base station device 200. Each path loss calculation unit 103 of MTC devices 100A, 100B calculates a path loss from the reception power during reception of the notification information and the transmitted transmission power included in the notification information.

Each comparison unit 104 of MTC devices 100A, 100B determines whether the calculated path loss is less than threshold Th1.

Each transmission unit 101 of MTC device 100 (that is, MTC devices 100A, 100B in subgroup A), determining that the path loss is less than threshold Th1, transmits a request signal for requesting access to base station device 200, to base station device 200 using radio resource RqA. On the other hand, each transmission unit 101 of MTC device 100PM (that is, MTC devices 100C, 100D in subgroup B), determining that the path loss is equal to or greater than threshold, transmits a request signal for requesting access to base station device 200, to base station device 200 using radio resource RqB.

Reception unit 203 of base station device 200 receives the request signal from each of MTC devices 100A, 100B in subgroup A. Reception unit 203 also receives the request signal from each of MTC devices 100C, 100D in subgroup B.

Allocation unit 201 allocates radio resource DtA (first radio resource) common in subgroup A, to each of MTC devices 100A, 100B that has transmitted the request signal. Allocation unit 201 further allocates radio resource DtB (second radio resource) common in subgroup B, to each of MTC devices 100C, 100D that has transmitted the request signal.

Transmission unit 202 of base station device 200 transmits an access enable signal (control information C1) including allocation information indicating allocation of radio resource DtA to each of MTC devices 100A, 100B communication devices that has transmitted the request signal. Transmission unit 202 also transmits an access enable signal (control information C2) including allocation information indicating allocation of radio resource DtB to each of MTC devices 100C, 100D that has transmitted the request signal.

Each reception unit 102 of MTC devices 100A, 100B in subgroup A receives the access enable signal (control information C1) including allocation information indicating allocation of radio resource DtA from base station device 200. On the other hand, each reception unit 102 of MTC devices 100C, 100D in subgroup B receives the access enable signal (control information C2) including allocation information indicating allocation of radio resource DtB from base station device 200.

Each transmission unit 101 of MTC devices 100A, 100B in subgroup A transmits target data (measurement data) to base station device 200, using radio resource DtA. Each transmission unit 101 of MTC devices 100C, 100D in subgroup B transmits target data (measurement data) to base station device 200, using radio resource DtB.

(2) A common group ID is set for each of MTC devices 100A to 100D in main group PM. A common group ID, different from that of main group PM, is set for each of MTC devices 100E to 100H in main group SC as well.

Allocation unit 201 of base station device 200 prepares radio resource RqA and radio resource RqB for each of MTC devices 100A to 100D having the group ID of main group PM. Allocation unit 201 prepares other two radio resources for each of MTC devices 100E to 100H having the group ID of main group SC.

(3) The access enable signal (control information C1) including allocation information indicating allocation of radio resource DtA and the access enable signal (control information C2) including allocation information indicating allocation of radio resource DtB include a plurality of device IDs for identifying MTC devices 100 (for example, FIG. 7).

The access enable signal (control information C1) including allocation information indicating allocation of radio resource DtA further includes a common signal format (MCS and/or TF) used by each of MTC devices 100A, 100B in subgroup A. The access enable signal (control information C2) including allocation information indicating allocation of radio resource DtB further includes a common signal format (MCS and/or TF) used by each of MTC devices 100C, 100D in subgroup B.

(4) The measurement data transmitted by each of MTC devices 100A, 100B in subgroup A is data based on the interleave division multiple access that is generated with an interleave pattern different for each of MTC devices 100A, 100B. Measurement data is generated with different interleave patterns even in subgroup A. Measurement data is generated with different interleave patterns also in subgroup B.

(5) In the application data format used in MTC devices 100 in main group PM, the block size of data is defined at a predetermined value. Also in the application data format used in MTC devices 100 in main group SC, the block size of data is defined at a predetermined value.

(6) MTC devices 100A to 100D in subgroup A have a power consumption measuring function such as an electric meter. MTC devices 100A to 100D further have the same traffic distribution in the communication with base station device 200. MTC devices 100E to 100H in subgroup B have an imaging function such as a monitoring camera. MTC devices 100E to 100H further have the same traffic distribution in the communication with base station device 200.

<F. Control Structure>

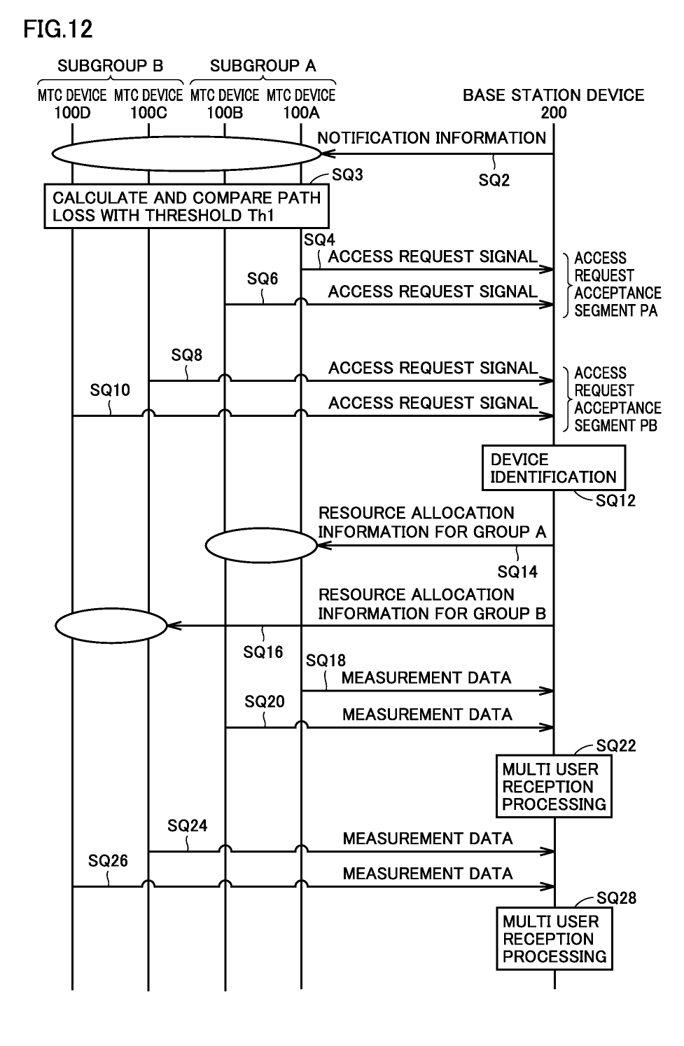

FIG. 12 is a sequence chart illustrating the procedure of the processing in wireless communication system 1. Specifically, FIG. 12 is a sequence chart focusing on MTC devices 100A to 100D belonging to main group PM as described above.

MTC devices 100A to 100D each perform position registration in advance and has an individual ID (for example, TMSI: temporary mobile subscriber identity) allocated as the device ID. The communication for position registration is not bound to the access request acceptance segment below. Alternatively, an ID (for example, IMEI: International Mobile Equipment Identity or IMSI: International Mobile Subscriber Identity) preset in, for example, a ROM (Read Only Memory) or a USIM (Universal Subscriber Identification Module) may be used as an individual device ID, without performing position registration.

Referring to FIG. 12, in sequence SQ2, MTC devices 100A to 100D each receive notification information from base station device 200. The notification information includes information representing allocation of the prepared radio, information representing threshold Th1 of the path loss, and information of transmission power for transmitting the notification information, as described above. That is, MTC devices 100A to 100D each receive information of access request acceptance segments PA, PB for the main group to which the device belongs to.

Here, MTC devices 100A to 100D each are configured such that MTC devices 100A to 100D in main group PM are able to receive only the information block including information of their main group. A not-shown non-MTC device (a user terminal other than MTC devices 100) is set so as not to receive such information. The notification information includes a set of PRACH resource block allocation, signal format, and available preamble sequence. The preamble sequence is a signal sequence used when an access request is transmitted. Alternatively, base station device 200 may individually announce similar information to MTC devices 100A to 100D during position registration.

In sequence SQ3, MTC devices 100A to 100D each calculate a path loss and determine whether the calculated path loss is less than threshold Th1. In the present embodiment, the path loss for MTC devices 100A, 100B is less than threshold Th1, and the path loss for MTC devices 100C, 100D is equal to or greater than threshold Th1. That is, MTC devices 100A, 100B are classified into subgroup A and MTC devices 100C, 100D are classified into subgroup B.

In sequence SQ4, MTC device 100A selects the preamble pattern associated with the device's own ID and transmits an access request signal in the access request acceptance segment PA selected from access request acceptance segments PA, PB designated (prepared) by base station device 200. In sequence SQ6, MTC device 100B selects the preamble pattern associated with the device's own ID and transmits an access request signal in the selected access request acceptance segment PA. That is, MTC devices 100A, 100B having the calculated path loss less than threshold Th1 transmit an access request signal in access request acceptance segment PA.

In sequence SQ8, MTC device 100C selects the preamble pattern associated with the device's own ID and transmits an access request signal in the access request acceptance segment PB selected from access request acceptance segments PA, PB designated (prepared) by base station device 200. In sequence SQ10, MTC device 100D selects the preamble pattern associated with the device's own ID and transmits an access request signal in the selected access request acceptance segment PB. That is, MTC devices 100C, 100D having the calculated path loss equal to or greater than threshold Th1 transmit an access request signal in access request acceptance segment PB.

For example, assume that the ID is provided in 16 bits, and the number of preamble patterns is 512. MTC devices 100A to 100D each select the preamble pattern corresponding to the lower nine bits of the ID. The preamble pattern is determined by a preamble sequence and a cyclic shift of the preamble sequence. Assuming that the sequence length is 839 in conformity with the pattern of PRACH of LTE, the above-noted number of patterns is ensured by a shift of one sequence. To increase the number of preamble patterns, the number of patterns may be increased by using a plurality of preamble sequences, or a preamble sequence having a long sequence length may be used.

In sequence SQ12, base station device 200 detects which preamble pattern is included in each of the signals received in access request acceptance segment PA and access request acceptance segment PB, for example, using a matched filter. Base station device 200 identifies MTC device 100 corresponding to the detected preamble pattern and then determines whether to perform transmission allocation. Since the IDs of MTC devices 100PM have one-to-many correspondence to a preamble pattern, base station device 200 may not always uniquely specify MTC device 100PM. In this case, base station device 200 performs transmission allocation to a plurality of MTC devices belonging to the group for which an access request acceptance segment is set, among the IDs of MTC devices 100PM corresponding to the preamble. If the number of MTC devices 100PM belonging to a group is large, such measures as increasing the number of preamble patterns are taken in sequence SQ4, SQ6, SQ8, SQ10.

In sequence SQ14, base station device 200 transmits an access enable signal including resource allocation information collectively to MTC devices 100A, 100B for which transmission allocation is performed. That is, base station device 200 transmits control information C1 including resource allocation information for subgroup A to MTC devices 100A, 100B in subgroup A.

In sequence SQ16, base station device 200 transmits an access enable signal including resource allocation information collectively to MTC devices 100C, 100D for which transmission allocation is performed. That is, base station device 200 transmits control information C2 including resource allocation information for subgroup B to MTC devices 100C, 100D in subgroup B.

In sequence SQ18, MTC device 100A transmits measurement data to base station device 200, using the allocated radio resource DtA. In sequence SQ20, MTC device 100B transmits measurement data to base station device 200, using the allocated radio resource. The measurement data transmitted by each of MTC device 100A and MTC device 100B is generated using IDMA. MTC devices 100A, 100B each use an interleaver having a pattern associated with the device's own ID.

In sequence SQ22, base station device 200 separately receives the signals of MTC devices 100A, 100B with the associated interleavers. The procedure of receiving the IDMA signal has been described and a description thereof is not repeated here.

In sequence SQ24, MTC device 100C transmits measurement data of power consumption, using the allocated radio resource DtB. In sequence SQ26, MTC device 100D transmits measurement data of power consumption, using the allocated radio resource DtB. The measurement data transmitted by each of MTC device 100C and MTC device 100D is generated using IDMA. MTC devices 100C, 100D each use an interleaver having a pattern associated with the device's own ID.

In sequence SQ28, base station device 200 separately receives the signals of MTC devices 100C, 100D with the associated interleavers. The procedure of receiving the IDMA signal has been described and a description thereof is not repeated here.

The method described in NPD 3 above does not carry out the procedure of access request and cannot identify which MTC device transmits. It is therefore necessary to try all interleavers in the base station device. However, in the method according to the present embodiment, since an access request is accepted in advance, it is only necessary to demodulate only the interleaver of MTC device 100PM for which base station device 200 has performed transmission allocation.

During reception of the preamble in sequence SQ12, the state of the propagation path between MTC device 100PM and base station device 200 may be determined, and the determination result may be used in sequence SQ22, SQ28.

In the foregoing description, base station device 200 may be configured so as to collectively transmit an access enable signal including resource allocation information to MTC devices 100A, 100B, 100C, 100D for which transmission allocation is performed, in place of sequence SQ14, SQ16.

### Second Embodiment

In the first embodiment, wireless communication system 1 performs processing based on a path loss. In the present embodiment, a configuration in which the processing based on the distance between a base station device 200′ and an MTC device is performed will be described.

<G. System Configuration>

FIG. 13 is a diagram illustrating an overall configuration of a wireless communication system 1′. Referring to FIG. 13, wireless communication system 1′ at least includes a plurality of MTC devices 100A′ to 100H′, base station device 200′, MME 300, and server device 400, similarly to wireless communication system 1 according to the first embodiment.

Base station device 200′ forms a cell 900. MTC devices 100A′ to 100H′ reside in cell 900 in which they can communication with base station device 200′. MTC devices 100A′, 100B′, 100G′, 100H′ reside in an area 820 including a position where base station device 200′ is installed. MTC devices 100C′ to 100F′ reside outside of area 820. Area 820 is an area in which the distance from base station device 200′ is L (threshold Th2). That is, area 820 is an area inside a circle with a radius L and with base station device 200′ at the center.

MTC devices 100A′ to 100H′ are communication devices that perform machine communication. MTC devices 100E′ to 100H′ are monitoring cameras. MTC devices 100A′ to 100D′ are electric meters. MTC devices 100A′ to 100H′ each have a communication function. MTC devices 100A′ to 100H′ each communicate with base station device 200′. Data (image data or measurement data) transmitted from MTC devices 100A′ to 100H′ is transmitted to server device 400 through base station device 200′ and MME 300.

In the following description, a single MTC device is referred to as “MTC device 100'” without differentiating MTC devices 100A′ to 100H′, for convenience of explanation. A single MTC device is referred to as “MTC device 100PM′” without differentiating MTC devices 100A′ to 100D′. A single MTC device is referred to as “MTC device 100SC′” without differentiating MTC devices 100E′ to 100H′.

The following description is focused on MTC devices 100A′ to 100D′ (that is, MTC devices 100PM′) in main group PM, for convenience of explanation. The same processing as in MTC devices 100A′ to 100D′ in main group PM is also performed in MTC devices 100E′ to 100H′ (that is, MTC device 100SC′) in main group SC. The detailed description of the processing in MTC devices 100E′ to 100H′ in main group SC will not be repeated.

<H. Process Overview>

An overview of the processing performed in wireless communication system 1 will be described below.

Base station device 200′ or MME 300 sets a different access request acceptance segment for each of main groups (main group PM, main group SC). More specifically, base station device 200′ or MME 300 sets the same access request acceptance segment for each of the subgroups (for example, subgroup A, subgroup B) belonging to the same main group.

Base station device 200′ or MME 300 sets an access request acceptance segment PC for sub groups A, B in main group PM. Wireless communication system 1′ may be configured such that an entity (not shown) other than base station device 200′ and MME 300 sets an access request acceptance segment. Specifically, base station device 200′ or MME 300 allocates common radio resource RqA to each of MTC devices 100A′ to 100D′ in subgroups A, B, by way of example.

MTC devices 100A′ to 100D′ each transmit an access request signal in a predetermined signal format to base station device 200′ in the access request acceptance segment set for each main group. Base station device 200′ transmits an access enable signal corresponding to the access request signal collectively to MTC devices 100A′ to 100D′.

Specifically, base station device 200′ allocates radio resource DtA common in subgroup A to each of MTC devices 100A′, 100B′ in subgroup A having the distance to base station device 200 less than threshold Th2 and allocates radio resource DtB common in subgroup B to each of MTC devices 100C′, 100D′ in subgroup B having the distance to base station device 200′ equal to or greater than threshold Th2.

Base station device 200′ transmits an access enable signal (control information C1) including resource allocation information indicating the allocation of radio resource DtA to each of MTC devices 100A′, 100B′ in subgroup A, and transmits an access enable signal (control information C2) including resource allocation information indicating the allocation of radio resource DtB to each of MTC devices 100C′, 100D′ in subgroup B.

MTC devices 100A′ to 100D′ each transmit data to base station device 200′ using a predetermined signal format, in accordance with the resource allocation information included in the access enable signal. Specifically, MTC devices 100A, 100B in subgroup A transmit data to base station device 200′ using radio resource DtA. MTC devices 100C, 100D in subgroup B transmit data to base station device 200′ using radio resource DtB.

Base station device 200′ simultaneously receives data from a plurality of MTC devices 100A′ to 100D′, using the multi user detection (MUD) technique.

In wireless communication system 1′, for the same reason as in wireless communication system 1, radio resource can be used more efficiently compared with a configuration in which a plurality of MTC devices 100A′ to H′ that transmit data to base station device 200′ using different application data formats are simply grouped (main groups PM, SC) so that access request, resource allocation, and data transmission are performed collectively (that is, a configuration without subgroup classification).

<I. Hardware Configuration>

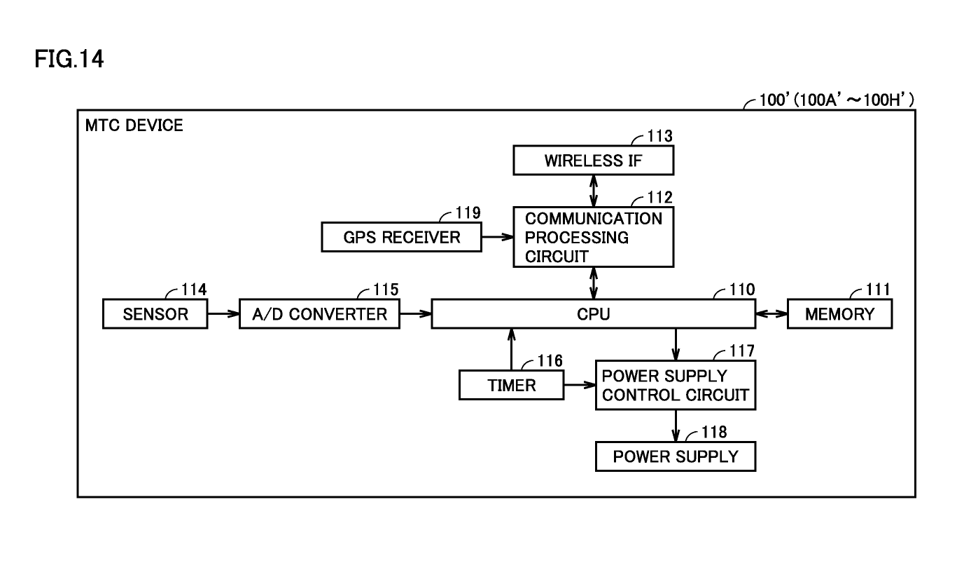

FIG. 14 is a diagram illustrating an overview of a hardware configuration of MTC device 100′. Referring to FIG. 14, MTC device 100′ includes a CPU (Central Processing Unit) 110, a memory 111, a communication processing circuit 112, a wireless IF 113, a sensor 114, an A/D (Analog to Digital) converter 115, a timer 116, a power supply control circuit 117, a power supply 118, and a GPS receiver 119.

GPS receiver 119 calculates the latitude and longitude of MTC device 100 based on radio waves from a plurality of artificial satellites. GPS receiver 119 sends information of the calculated latitude and longitude as positional information to communication processing circuit 112. The positional information is transmitted to base station device 200′ through wireless IF 113 at a predetermined timing under a command from CPU 110.

The hardware configuration of base station device 200′ is similar to the hardware configuration (FIG. 4) of base station device 200 in the first embodiment and a description is not repeated here.

<J. Details of Processing>

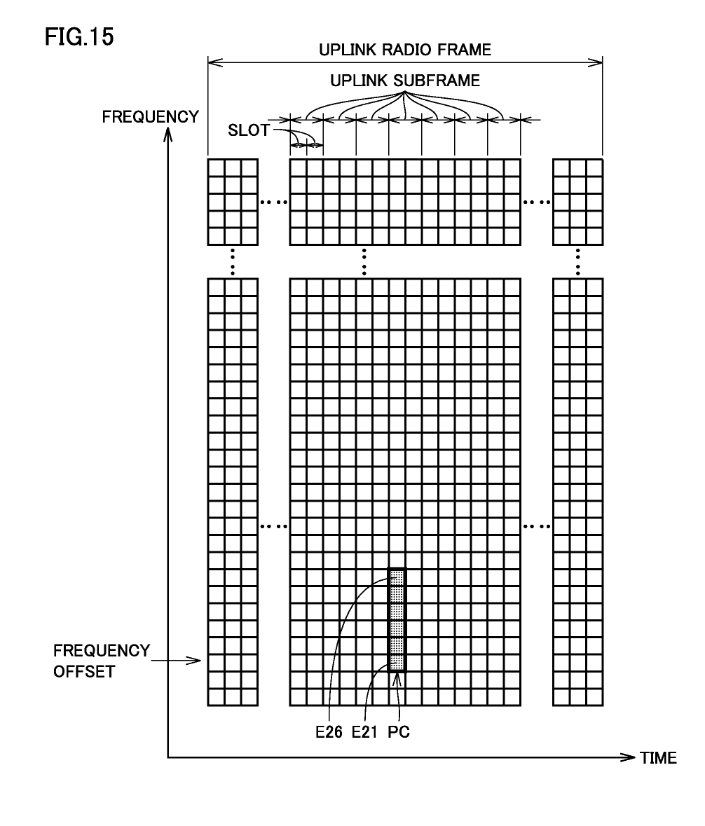

FIG. 15 is a diagram illustrating an example of the access request acceptance segment. Specifically, FIG. 15 illustrates access request acceptance segment PC allocated to subgroups A, B. MTC devices 100A′ to 100D′ determine access request acceptance segment PC, based on the number of the frame, the number of the uplink subframe, and the frequency offset corresponding to main group PM.

Referring to FIG. 15, MTC devices 100A′ to 100D′ transmit an access request to base station device 200′ in the allocated access request acceptance segment PC. Access request acceptance segment PC is configured with six resource blocks in succession in the frequency direction, in a predetermined subframe (uplink subframe) in one frame. Specifically, access request acceptance segment PC is a segment defined by a resource block E21 and a resource block E26.

Base station device 200′ receives access request signals transmitted from MTC devices 100. Base station device 200′ identifies which MTC device 100 has transmitted the access request signal based on the receive signal. Base station device 200′ confirms that the received access request signals are the access request signals from devices in the designated main group. If the number of access request signals is equal to or smaller than a permissible number, base station device 200′ transmits a control signal including resource allocation information (access enable, scheduling) to these MTC devices 100.

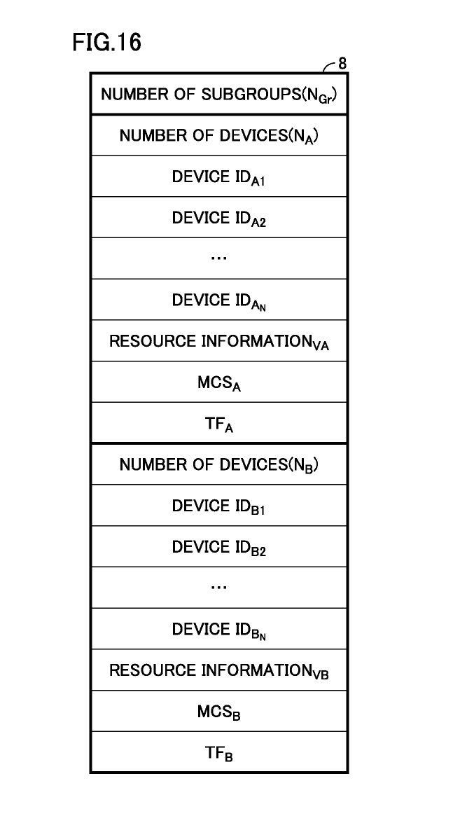

FIG. 16 is a diagram illustrating a format 8 of the resource allocation information in the present embodiment. Referring to FIG. 16, the number of subgroups (NGr) is the number of subgroups included in one main group. In the present embodiment, two groups are formed (for example, subgroups A, B) according to the distance, and NGr=2. The number of devices (N_{A}) is the number of MTC devices PM′ to which allocation is performed in subgroup A. The number of devices (N_{B}) is the number of MTC devices PM′ to which allocation is performed in subgroup B. For example, in the case in FIG. 13, N_{A}=2, N_{B}=2.

The device IDs (ID_{A1} to ID_{AN}) indicate the IDs of MTC devices 100PM′ belonging to subgroup A. The device IDs (ID_{B1} to ID_{BN}) indicate the IDs of MTC devices 100PM′ belonging to subgroup B. Resource information v_{A} includes information of the start position and the length of the resource block allocated to MTC device 100PM′ belonging to subgroup A. Resource information v_{B} includes information of the start position and the length of the resource block allocated to MTC device 100PM′ belonging to subgroup B.

NA MTC devices 100PM′ specified by device ID_{A1} to ID_{AN} in the format 8 transmit data to base station device 200′, using a common MCS_{A} and a common TF_{A}, in the resource blocks designated by resource information v_{A}. NB MTC devices 100PM′ specified by device ID_{B1} to ID_{BN} transmit data to base station device 200′ using a common MCS_{B} and a common TF_{B}, in the resource blocks designated by resource information v_{B}.

That is, MTC devices 100PM′ belonging to subgroup A transmit measurement data to base station device 200′ using the common MCS_{A} and the common TF_{A} in segment QC, while MTC devices 100PM′ belonging to subgroup B transmit measurement data to base station device 200′ using the common MCS_{B} and the common TF_{B} in segment QD.

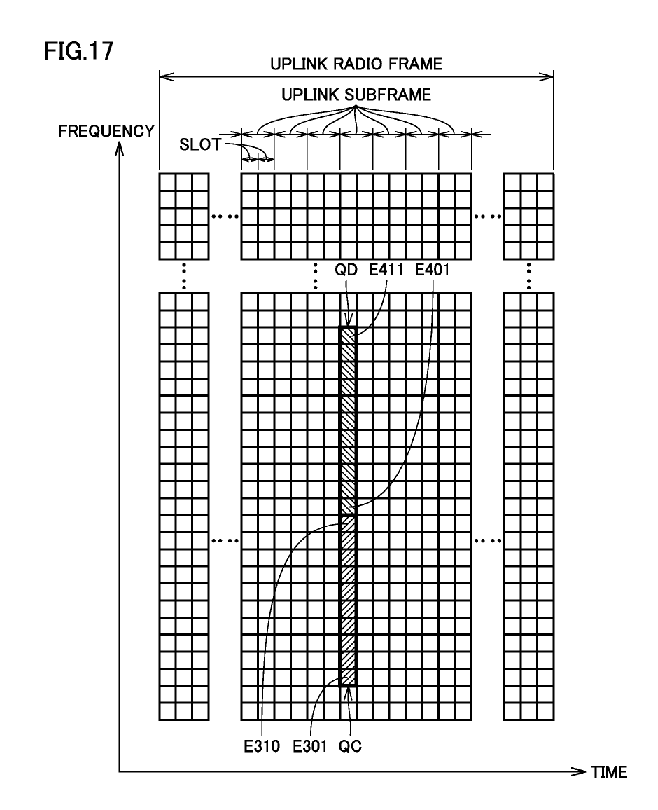

FIG. 17 is a diagram illustrating an example of the allocated resource. Referring to FIG. 17, for example, MTC devices 100A′, B′ in subgroup A transmit data to base station device 200′ in the allocated segment QC. The segment QC is configured with 10 resource blocks in succession in the frequency direction, in a predetermined uplink subframe in one frame. Specifically, the segment QB is a segment defined by a resource block E301 and a resource block E310.

MTC devices 100C′, D′ in subgroup B transmit data to base station device 200′ in the allocated segment QD. The segment QD is configured with 11 resource blocks in succession in the frequency direction, in a predetermined uplink subframe in one frame. Specifically, the segment QD is a segment defined by a resource block E401 and a resource block E411. Resource block E401 is adjacent to resource block E310.

<K. Functional Configuration>

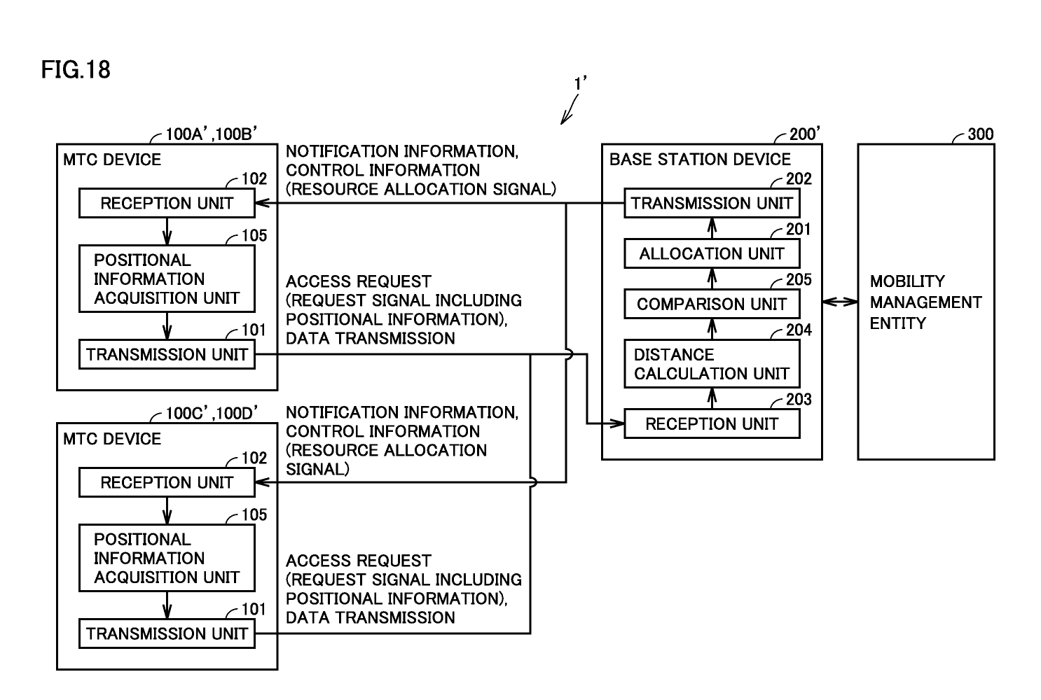

FIG. 18 is a diagram illustrating a functional configuration of MTC devices 100A′ to 100D′ and a functional configuration of base station device 200′. In FIG. 18, only MTC devices 100A′ to 100D′ are illustrated for convenience of explanation. Referring to FIG. 18, MTC devices 100A′ to 100D′ each include a transmission unit 101, a reception unit 102, and a positional information acquisition unit 105. Base station device 200′ includes an allocation unit 201, a transmission unit 202, a reception unit 203, a distance calculation unit 204, and a comparison unit 205.

(1) Allocation unit 201 of base station device 200′ allocates ratio resource RqA for MTC devices 100A′ to 100D′ to make an access request, to each of MTC devices 100A′ to 100D′ in main group PM that transmit data to base station device 200′ using a predetermined one application data format, among a plurality of MTC devices 100. Transmission unit 202 transmits notification information to each of MTC devices 100A′ to 100D′. The notification information includes information indicating the radio allocation.

Each reception unit 102 of MTC devices 100A′ to 100D′ receives the notification information from base station device 200′. Each positional information acquisition unit 105 of MTC devices 100A′ to 100D′ uses a GPS function to acquire the device's own positional information. Each transmission unit 101 of MTC devices 100A′ to 100D′ transmits a request signal including the positional information for requesting access to base station device 200′, to base station device 200′, using the allocated radio resource RqA.

Reception unit 203 of base station device 200′ receives the request signal including the positional information from each of MTC devices 100A′ to 100D′. Distance calculation unit 204 calculates the distance between each of MTC devices 100A′ to 100D′ and the base station device, using the received positional information. Comparison unit 205 determines whether the calculated distance is less than threshold Th2. Base station device 200′ stores threshold Th2 in advance.

Allocation unit 201 allocates radio resource DtA (first radio resource) common in subgroup A, to each of MTC devices 100A′, 100B′ having the calculated distance less than threshold Th2. Allocation unit 201 further allocates radio resource DtB (second radio resource) common in subgroup B, to each of MTC devices 100C′, 100D′ having the calculated distance equal to or greater than threshold Th2.

Transmission unit 202 of base station device 200′ transmits an access enable signal (control information C1) including allocation information indicating allocation of radio resource DtA to each of MTC devices 100A′, 100B′ communication devices. Transmission unit 202 also transmits an access enable signal (control information C2) including allocation information indicating allocation of radio resource DtB to each of MTC devices 100C′, 100D′.

Each reception unit 102 of MTC devices 100A′, 100B′ in subgroup A receives the access enable signal (control information C1) including allocation information indicating allocation of radio resource DtA from base station device 200′. On the other hand, each reception unit 102 of MTC devices 100C′, 100D′ in subgroup B receives the access enable signal (control information C2) including allocation information indicating allocation of radio resource DtB from base station device 200′.

Each transmission unit 101 of MTC devices 100A′, 100B′ in subgroup A transmits target data (measurement data) to base station device 200′, using radio resource DtA. Each transmission unit 101 of MTC devices 100C′, 100D′ in subgroup B transmits target data (measurement data) to base station device 200′, using radio resource DtB.

(2) A common group ID is set for each of MTC devices 100A′ to 100D′ in main group PM. A common group ID, different from that of main group PM, is set for each of MTC devices 100E′ to 100G′ in main group SC as well.

Allocation unit 201 of base station device 200′ allocates radio resource RqA for access request to each of MTC devices 100A′ to 100D′ having the group ID of main group PM. Allocation unit 201 also allocates other radio resource for access request to each of MTC devices 100E′ to 100H′ having the group ID of main group SC.

(3) The access enable signal (control information C1) including allocation information indicating allocation of radio resource DtA and the access enable signal (control information C2) including allocation information indicating allocation of radio resource DtB include a plurality of device IDs for identifying MTC devices 100 (for example, FIG. 16).

The access enable signal (control information C1) including allocation information indicating allocation of radio resource DtA further includes a common signal format (MCS and/or TF) used by each of MTC devices 100A′, 100B′ in subgroup A. The access enable signal (control information C2) including allocation information indicating allocation of radio resource DtB further includes a common signal format (MCS and/or TF) used by each of MTC devices 100C′, 100D′ in subgroup B.

(4) The measurement data transmitted by each of MTC devices 100A′, 100B′ in subgroup A is data based on the interleave division multiple access that is generated with an interleave pattern different for each of MTC devices 100A′, 100B′. That is, measurement data is generated with different interleave patterns even in subgroup A. Measurement data is generated with different interleave patterns also in subgroup B.

(5) In the application data format used in MTC devices 100A′ to 100D′ in main group PM, the block size of data is defined at a predetermined value. In the application data format used in MTC devices 100E to 100H′ in main group SC, the block size of data is also defined at a predetermined value.

(6) MTC devices 100A′ to 100D′ in main group PM have a power consumption measuring function such as an electric meter. MTC devices 100A′ to 100D′ further have the same traffic distribution in the communication with base station device 200′. MTC devices 100E′ to 100G′ in main group SC have an imaging function such as a monitoring camera. MTC devices 100E′ to 100G′ further have the same traffic distribution in the communication with base station device 200′.

<L. Control Structure>

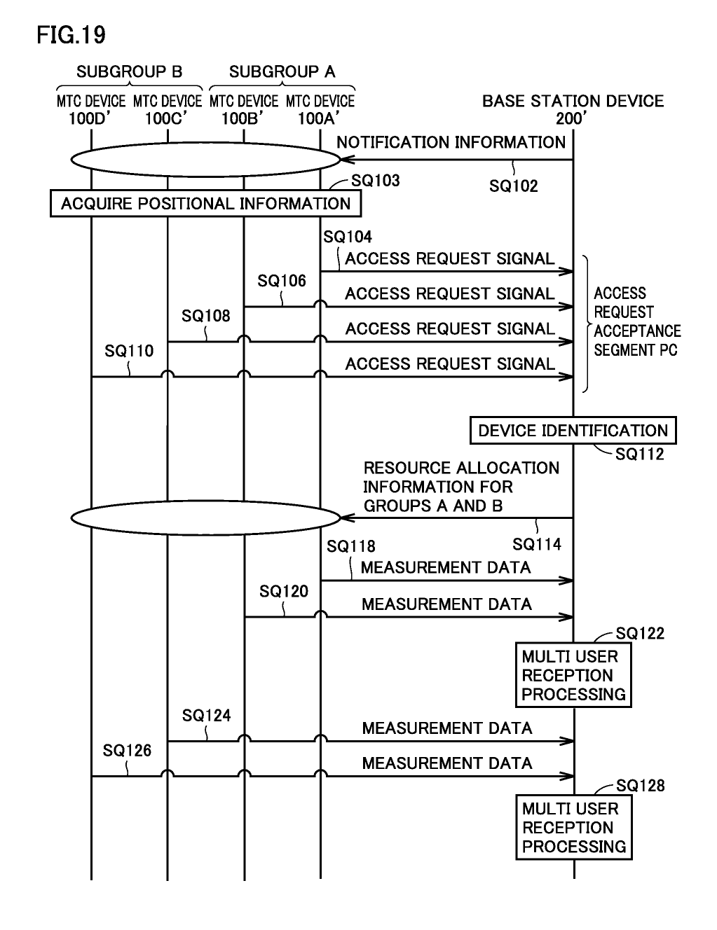

FIG. 19 is a sequence chart illustrating the procedure of the processing in wireless communication system 1′. Specifically, FIG. 12 is a sequence chart focusing on MTC devices 100A′ to 100D′ belonging to main group PM as described above.

MTC devices 100A′ to 100D′ each perform position registration in advance in the same manner as in the first embodiment and each are allocated an individual ID as the device ID.

Referring to FIG. 19, in sequence SQ102, MTC device 100A′ to 100D′ each receive notification information from base station device 200. The notification information includes information indicating radio allocation, as described above. That is, MTC devices 100A to 100D each receive information of access request acceptance segment PC for main group PM′.

Here, MTC devices 100A′ to 100D′ each are configured such that MTC devices 100A to 100D in main group PM are able to receive only the information block including information of their main group. A not-shown non-MTC device (a user terminal other than MTC devices 100) is set so as not to receive such information. The notification information includes a set of PRACH resource block allocation, signal format, and available preamble sequence. Alternatively, base station device 200 may individually announce similar information to MTC devices 100A′ to 100D′ during position registration.

In sequence SQ103, MTC devices 100A′ to 100D′ each acquire positional information. In sequence SQ104, MTC device 100A′ selects the preamble pattern associated with the device's own ID and transmits an access request signal in access request acceptance segment PC designated by base station device 200′. In sequence SQ106, MTC device 100B′ selects the preamble pattern associated with the device's own ID and transmits an access request signal in access request acceptance segment PC.

In sequence SQ108, MTC device 100C′ selects the preamble pattern associated with the device's own ID and transmits an access request signal in the designated access request acceptance segment PC. In sequence SQ110, MTC device 100D′ selects the preamble pattern associated with the device's own ID and transmits an access request signal in access request acceptance segment PC. That is, MTC devices 100A′ to 100D′ belonging to main group PM transmit an access request signal in the same access request acceptance segment PC.

In sequence SQ112, base station device 200′ detects which preamble pattern is included in each of the signals received in access request acceptance segment PC, for example, using a matched filter. Base station device 200′ identifies MTC device 100PM corresponding to the detected preamble pattern and then determines whether to perform transmission allocation.

In sequence SQ112, base station device 200′ calculates the distance between each of MTC devices 100A′ to 100D′ and base station device 200′, based on the positional information received from each of MTC devices 100A′ to 100D′. Base station device 200′ then performs grouping, according to whether the calculated distance is less than threshold Th2. In the embodiment, the distance for MTC devices 100A′, 100B′ is less than threshold Th2, and the distance for MTC devices 100C′, 100D′ is equal to or greater than threshold Th2. Base station device 200′ then classifies MTC devices 100A′, 100B′ into subgroup A and classifies MTC devices 100C′, 100D′ into subgroup B.

In sequence SQ114, base station device 200′ transmits an access enable signal including resource allocation information collectively to MTC devices 100A′ to 100D′ for which transmission allocation is performed. That is, base station device 200′ transmits control information including resource allocation information for subgroup A and resource allocation information for subgroup B to MTC devices 100A′ to 100D′. In doing so, base station device 200′ additionally transmits information for identifying the device's group to MTC devices 100A′ to 100D′. Base station device 200′ may transmit control information individually to each subgroup A, B.

In sequence SQ118, MTC device 100A′ transmits measurement data to base station device 200′, using the allocated radio resource DtA. In sequence SQ120, MTC device 100B′ transmits measurement data to base station device 200′, using the allocated radio resource DtA. The measurement data transmitted by each of MTC device 100A′ and MTC device 100B′ is generated using IDMA. MTC devices 100A, 100B each use an interleaver having a pattern associated with the device's own ID. In sequence SQ122, base station device 200′ separately receives the signals of MTC devices 100A′, 100B′ with the associated interleavers.

In sequence SQ124, MTC device 100C′ transmits measurement data of power consumption, using the allocated radio resource DtB. In sequence SQ126, MTC device 100D′ transmits measurement data of power consumption, using the allocated radio resource DtB. The measurement data transmitted by each of MTC device 100C′ and MTC device 100D′ is generated using IDMA. MTC devices 100C′, 100D′ each use an interleaver having a pattern associated with the device's own ID. In sequence SQ128, base station device 200′ separately receives the signals of MTC devices 100C′, 100D′ with the associated interleavers.

The method described in NPD 3 above does not carry out the procedure of access request and cannot identify which MTC device transmits. It is therefore necessary to try all interleavers in the base station device. However, in the method according to the present embodiment, since an access request is accepted in advance, it is only necessary to demodulate only the interleaver of MTC device 100PM′ for which base station device 200 has performed transmission allocation.

During reception of the preamble in sequence SQ112, the state of the propagation path between MTC device 100PM′ and base station device 200 may be determined, and the determination result may be used in sequence SQ122, SQ128.

<M. Modification>

(1) In the first embodiment, one threshold is set for the path loss. However, the embodiment is not limited thereto, and a plurality of thresholds may be set. In this case, base station device 200 may be configured so as to perform radio resource allocation for making an access request and radio resource allocation for transmitting measurement data and video data, for each group classified by the thresholds.

Similarly, in the second embodiment, one threshold is set for the distance. However, the embodiment is not limited thereto, and a plurality of thresholds may be set.

(2) In the second embodiment, MTC devices 100A′ to D′ acquire positional information in sequence SQ103. In place of sequence SQ103, MTC devices 100A′ to D′ may calculate the path loss and make an access request including the calculated path loss value in sequence SQ104, SQ106, SQ108, SQ110. In this case, unlike the first embodiment, the comparison between the path loss and threshold Th1 is performed by base station device 200. The classification of subgroups (classification into subgroups A, B, for example) is also performed by base station device 200. The other processing is the same as the processing after sequence SQ114 shown in the second embodiment.

### DESCRIPTION OF THE REFERENCE SIGNS

1, 1′ wireless communication system, 100, 100A to 100H, 100SC, 100PM MTC device, 101, 202 transmission unit, 102, 203 reception unit, 103 path loss calculation unit, 104, 205 comparison unit, 105 positional information acquisition unit, 110 CPU, 111 memory, 112 communication processing circuit, 113 wireless IF, 114 sensor, 115 converter, 116 timer, 117 power supply control circuit, 118 power supply, 119 GPS receiver, 200, 200′ base station device, 201 allocation unit, 204 distance calculation unit, 210 antenna, 230 wireless processing unit, 250 baseband unit, 251 baseband circuit, 252 control device, 253 timing control unit, 254 communication interface, 255 power supply device, 300 MME, 400 server device, 810, 820 area, 900 cell, E1, E6, E11, E16, E21, E26, E101, E108, E201, E210, E301, E310, E401, E411 resource block, QA, QB, QC, QD segment.

1. A wireless communication system comprising: a plurality of communication devices each performing machine communication; and a base station device performing wireless communication with the plurality of communication devices,
wherein the plurality of communication devices are divided into communication devices in a first group that transmit data to the base station device using a first application data format and communication devices in a second group that transmit data to the base station device using a second application data format,
the base station device includes an allocation unit for allocating first radio resource for allowing transmission of the data to, of the communication devices in the first group, each of communication devices having a path loss less than a threshold for a predetermined signal transmitted from the base station device, and for allocating second radio resource for allowing transmission of the data to each of communication devices having the path loss equal to or greater than the threshold,
each of the communication devices having the path loss less than the threshold includes a first transmission unit for transmitting the data using the first radio resource to the base station device, and
each of the communication devices having the path loss equal to or greater than the threshold includes a second transmission unit for transmitting the data using the second radio resource to the base station device.

2. The wireless communication system according to claim 1, wherein
the base station device transmits a transmission intensity of the predetermined signal and the threshold for the path loss to each of the communication devices in the first group, and
each of the communication devices in the first group determines whether the path loss is less than the threshold, using a reception intensity and the transmission intensity of the predetermined signal.

3. The wireless communication system according to claim 1, wherein
each of the communication devices in the first group transmits the data to the base station device after transmitting to the base station device a request signal for requesting access to the base station device, and
the allocation unit allocates third radio resource for allowing transmission of the request signal, to each of the communication devices having the path loss less than the threshold, and allocates fourth radio resource for allowing transmission of the request signal, to each of the communication device having the path loss equal to or greater than the threshold.

4. A wireless communication system comprising: a plurality of communication devices each performing machine communication; and a base station device performing wireless communication with the plurality of communication devices,
wherein the plurality of communication devices are divided into communication devices in a first group that transmit data to the base station device using a first application data format and communication devices in a second group that transmit data to the base station device using a second application data format,
the base station device includes an allocation unit for allocating first radio resource for allowing transmission of the data to, of the communication devices in the first group, each of communication devices having a distance from the base station device less than a threshold, and for allocating second radio resource for allowing transmission of the data to each of communication devices having the distance equal to or greater than the threshold,
each of the communication devices having the distance less than the threshold includes a first transmission unit for transmitting the data using the first radio resource to the base station device, and
each of the communication devices having the distance equal to or greater than the threshold includes a second transmission unit for transmitting the data using the second radio resource to the base station device.

5. The wireless communication system according to claim 4, wherein
each of the communication devices in the first group transmits, to the base station device, a request signal for requesting access to the base station and positional information representing a position of the communication device, before transmitting the data,
the base station device further includes a calculation unit for calculating, for each of the communication devices in the first group, a distance between the communication device and the base station device, based on the positional information, and
the allocation unit allocates the first radio resource or the second radio resource to each of the communication devices in the first group, based on the calculated distance.
